(19) United States
(12) Patent Application Publication
(10) Pub. No.: US 2017/0312902 A1
(43) Pub. Date: Nov. 2, 2017

(54) POWERED WORKING MACHINE

(71) Applicant: Hitachi Koki Co., Ltd., Tokyo (JP)

(72) Inventors: Yuta NOGUCHI, IBARAKI (JP); Kazutaka IWATA, IBARAKI (JP); Kazuhiko FUNABASHI, IBARAKI (JP); Tomoaki SUDO, IBARAKI (JP); Ken INUI, IBARAKI (JP); Naoki TADOKORO, IBARAKI (JP)

(73) Assignee: Hitachi Koki Co., Ltd., Tokyo (JP)

(21) Appl. No.: 15/522,294

(22) PCT Filed: Oct. 21, 2015
(86) PCT No.: PCT/JP2015/079711

§ 371 Date: Apr. 27, 2017

(30) Foreign Application Priority Data
Oct. 29, 2014 (JP) 2014-220309
Nov. 28, 2014 (JP) 2014-242073

(51) Int. Cl. B25D 17/24; B25D 11/12; B25F 5/00; B25F 5/02

(52) U.S. Cl. CPC B25D 17/24; B25F 5/02; B25D 11/125; B25F 5/006

(57) ABSTRACT

A powered working machine (10) with which the transmission of vibrations from a housing to a control substrate can be suppressed, operates a distal tool using power from a brushless motor (30), is configured to have: a control substrate (71) that controls the brushless motor (30); a substrate case (82) that accommodates the control substrate (71); a motor housing (20) and cover (160) that support the substrate case (82); an elastic body (152) that is disposed between the substrate case (82) and the motor housing (20); and an elastic body (153) that is disposed between the substrate case (82) and the cover (160).

### TECHNICAL FIELD

The disclosure relates to a powered working machine configured to operate a working tool with power of a motor.

### BACKGROUND ART

A powered working machine configured to operate a working tool with power of a motor is disclosed in Patent Literature 1. The powered working machine disclosed in Patent Literature 1 is a hammer drill. The hammer drill disclosed in Patent Literature 1 includes a motor installed in a housing, a tool support member rotated by power of the motor and configured to support a working tool, a power conversion mechanism configured to convert power of the motor into a striking force, and an intermediate piece configured to transmit the striking force to the working tool. The power conversion mechanism has a cylinder having a cylindrical shape, a piston installed in the cylinder, and a striking element disposed in the cylinder and configured to form a pressure chamber between the piston and the striking element. The piston, the striking element and the intermediate piece are operating members operated in a direction along a centerline of the cylinder.

In addition, the hammer drill can be switched between a hammer mode and a hammer drill mode. When the hammer mode is selected, power of the motor is converted into a striking force, and the striking force is transmitted to the working tool. When the hammer drill mode is selected, in addition to transmission of the striking force to the working tool, the rotating force is transmitted to the working tool.

In the hammer drill disclosed in Patent Literature 1, a sensor unit is installed in the housing. The sensor unit includes a control board and an inclination sensor attached to the control board. The inclination sensor is a sensor configured to detect an inclination angle of the working tool with respect to 0 degrees when the working tool is pushed against the ground surface and the housing is inclined using a state in which the working tool is vertical as 0 degrees. Then, lighting of light emitting diode (LED) lamps having different colors is controlled according to the inclination angle of the working tool. In addition, the sensor unit includes an elastic member disposed to wrap around a sensor board to which the inclination sensor s attached. Further, vibrations transmitted to the control board can be reduced, and damage to the inclination sensor can be prevented.

Meanwhile, as the powered working machine, a small electric tool such as an impact driver, an impact wrench, or the like, using a brushless motor as a driving source is known. In such an electric tool, the hammer rotated and driven by the brushless motor strokes an anvil and a tip tool mounted on the anvil is rotated. Accordingly, work such as fastening or the like of a latch becomes possible. In the electric tool using the brushless motor, since the brushless motor can be electronically controlled because the tool main body can be reduced in size and a coil of a stator is connected to a board configured to drive the motor through soldering, appropriate workability can be obtained and power consumption is reduced. Meanwhile, since vibrations generated when the hammer strikes the anvil are transmitted to the motor and the board via the housing, exfoliation of mounted elements due to flexure of the board, disconnection of the coil, or the like, may occur.

In order to solve these problems, in the related art, an electric tool in which a coil and a board are connected via a connector is used (for example, see Patent Literature 2). Here, a connected state of the motor and the board in the electric tool in the related art will be described based on FIG. 23 and FIG. 24. FIG. 23 is a perspective view showing a partial configuration of a motor in an electric tool according to an example of a powered working machine in the related art, and FIG. 24 is a side view showing a partial configuration of the motor in the electric tool in the related art.

A stator 633 that constitutes a motor 603 is formed in a substantially cylindrical shape, and an insulator 637 is disposed at an end portion of the stator 633 in an axial direction. The insulator 637 has a base section 637a having a substantially cylindrical shape and insulates the stator 633 and a coil 635. In addition, a plurality of board positioning sections 637f configured to position a board 606 are formed on the base section 637a of the insulator 637 to protrude in the axial direction of the stator 633. Further, a plurality of connector support sections 637h protruding in the axial direction of the stator 633 are formed on the base section 637a of the insulator 637, and a connector 639 is engaged with the connector support sections 637h to be supported.

The connector 639 has an engaging section 639a engaged with the connector support sections 637h of the insulator 637, protrusions 639b protruding in the axial direction of the stator 633, and an inclined section 639c inclined in a radial direction of the stator 633. The protrusions 639b are portions connected to the board 606, and the inclined section 639c is a portion on which the coil 635 is wound to be connected.

The board 606 is disposed to cover the insulator 637 and the connector 639, and positioned by a positioning section 637f of the insulator 637. In addition, a plurality of hole portions (not shown) are formed in the board 606, and the protrusions 639b of the connector 639 are fitted into each of the hole portions. A fitting portion between the protrusions 639b of the connector 639 and the hole portions of the board 606 is fixed by soldering.

In this way, in the electric tool in the related art, the coil is connected to the board via the connector fixed to the board by soldering.

### CITATION LIST

### Patent Literature

Patent Literature 1: Japanese Unexamined Patent Application Publication No. 2013-94870
Patent Literature 2: Japanese Unexamined Patent Application Publication No. H02-079760

### SUMMARY OF DISCLOSURE

### Technical Problem

However, in the powered working machine disclosed in Patent Literature 1, an elastic body is merely installed between the control board and the housing, and there is a probability of vibrations of the control board not being able to be sufficiently reduced.

Meanwhile, in recent times, a powered working machine (for example, an electric tool) having a small size and a large output has been required. However, in the electric tool having the large output, since generated vibrations are also increased, even when the coil and the board are connected via the connector, flexure of the board or disconnection of the coil, falling of the soldered connector, and so on may occur.

The disclosure is directed to providing a powered working machine capable of suppressing transmission of vibrations of a housing to a control board. In addition, the disclosure is directed to providing a powered working machine capable of suppressing occurrence of flexure of a board due to transmission of vibrations without an increase in size of a tool main body even when the powered working machine (an electric tool) has a large output.

### Solution to Problem

The disclosure provides a powered working machine configured to operate a working tool with a power of a motor, the powered working machine having a control board configured to control the motor, a board case configured to accommodate the control board, a housing configured to support the board case, and an elastic body interposed between the board case and the housing.

In addition, the disclosure provides a powered working machine including a board, a motor connected to the board, a housing configured to accommodate the board and the motor, and an output section driven by the motor, wherein an elastic body is disposed on a vibration transmission path from the output section to the board.

### Advantageous Effects of Disclosure

According to the disclosure, vibrations of the housing can be reduced by the elastic body, and transmission of the vibrations of the housing to the control board can be suppressed. According to the disclosure, transmission of the vibrations to the board can be suppressed, and occurrence of flexure of the board can be suppressed.

### BRIEF DESCRIPTION OF DRAWINGS

FIG. 1 is a front cross-sectional view of an electric working machine corresponding to Embodiment 1 of the disclosure.

FIG. 2 is a block diagram showing a control circuit of the electric working machine of FIG. 1.

FIG. 3 is an enlarged front cross-sectional view of a major part of the electric working machine of FIG. 1.

FIG. 4 is a side view of a control unit used in the electric working machine of FIG. 1.

FIG. 5 is a cross-sectional view showing a connecting structure between a connector and a lead wire shown in FIG. 4.

FIG. 6 is a cross-sectional view of a display case installed in the electric working machine of FIG. 1.

FIG. 7 is a side view showing the display case shown in FIG. 6 with a cover removed.

FIG. 8 is a front cross-sectional view showing a portion of an electric working machine corresponding to Embodiment 2 of the disclosure.

FIG. 9 is a cross-sectional view showing a configuration of an impact wrench serving as an electric working machine corresponding to Embodiment 3 of the disclosure.

FIG. 10 is a cross-sectional view taken along line A-A of FIG. 9, showing a support section of a motor in the impact wrench according to Embodiment 3.

FIG. 11(a) and FIG. 11(h) show a perspective view showing a partial configuration of the motor in the impact wrench according to Embodiment 3 and a partially enlarged view showing an engaging portion of a connector and an insulator. FIG. 11(a) is the perspective view of the motor and FIG. 11(b) is the enlarged view of a portion B in FIG. 11(a).

FIG. 12(a) and FIG. 12(b) show a side view and a partially enlarged view showing a partial configuration of the motor in the impact wrench according to Embodiment 3. FIG. 12(a) is the side view of the motor and FIG. 12(b) is a cross-sectional view taken along line C-C of FIG. 12(a).

FIG. 13 is a view showing a connecting portion of a connector and a circuit board in the impact wrench according to Embodiment 3.

FIG. 14(a) and FIG. 14(b) are schematic views showing a configuration of the circuit board in the impact wrench according to Embodiment 3. FIG. 14(a) is a plan view showing the entire circuit board and FIG. 14(b) is an enlarged view of a portion D in FIG. 14(a).

FIG. 15(a) and FIG. 15(b) show a perspective view showing a partial configuration of a motor in an impact wrench according to Embodiment 4 and a partially enlarged view showing an engaging portion of a connector and an insulator. FIG. 15(a) is the perspective view of the motor and FIG. 15(b) is the enlarged view of a portion E in FIG. 15(a).

FIG. 16(a) and FIG. 16(b) show a side view and a partially enlarged view showing a partial configuration of the motor in the impact wrench according to Embodiment 4. FIG. 16(a) is the side view of the motor and FIG. 16(h) is a cross-sectional view taken along line F-F of FIG. 16(a).

FIG. 17(a) to FIG. 17(d) show a configuration of a conductive rubber and a connector in an impact wrench according to Embodiment 5. FIG. 17(a) is a view showing a configuration of the conductive rubber and FIG. 17(b) is a view showing an engaging portion of the conductive rubber and the connector. FIG. 17(c) is a view showing a connecting portion of the conductive rubber, the connector and a circuit board, and FIG. 17(d) is a view showing an engaging portion of the connector and an insulator.

FIG. 18(a) and FIG. 18(b) are schematic views showing a configuration of the circuit hoard in the impact wrench according to Embodiment 5. FIG. 18(a) is a plan view showing the entire circuit hoard and FIG. 18(b) is an enlarged view of a portion G in FIG. 18(a).

FIG. 19(a) and FIG. 19(b) are views showing a configuration of a connector in an impact wrench according to Embodiment 6. FIG. 19(a) is a view showing a connecting portion of the connector and a circuit hoard and FIG. 19(h) is a view showing an engaging portion of the connector and an insulator.

FIG. 20 is a view of a connecting portion of a housing and a motor in an impact wrench according to Embodiment 7, showing a cross-sectional view taken along line A-A of FIG. 9.

FIG. 21 is a cross-sectional view showing a configuration of an impact wrench according to Embodiment 8.

FIG. 22 is a view of a support portion of a circuit board in the impact wrench according to Embodiment 8, showing an enlarged view of a portion H of FIG. 21.

FIG. 23 is a perspective view showing a partial configuration of a motor in an electric tool in the related art.

FIG. 24 is a side view showing a partial configuration of the motor in the electric tool in the related art.

### DESCRIPTION OF EMBODIMENTS

Hereinafter, powered working machines of embodiments of the disclosure will be described in detail with reference to the accompanying drawings.

### Embodiment 1

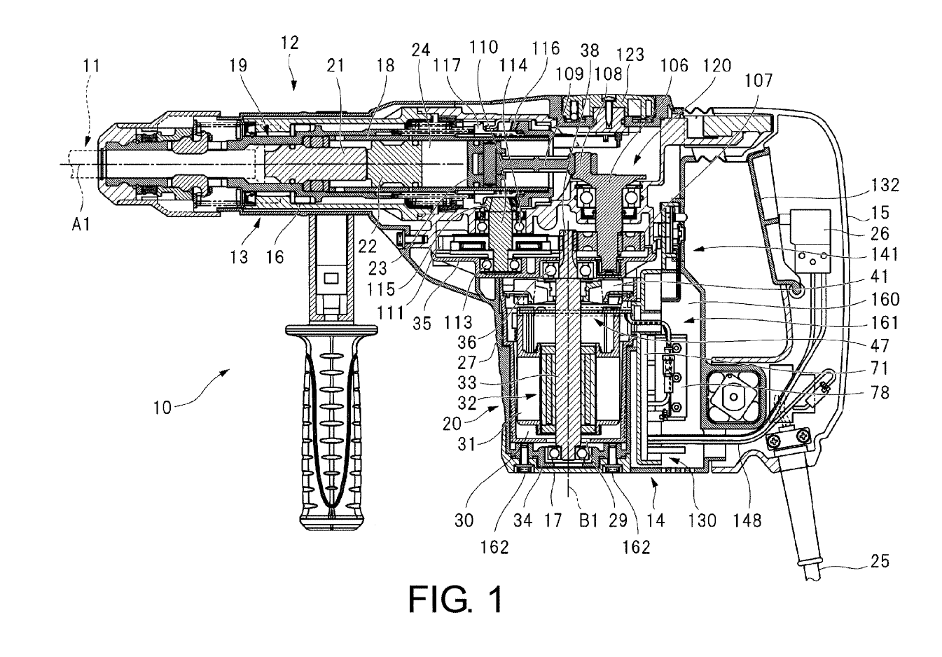

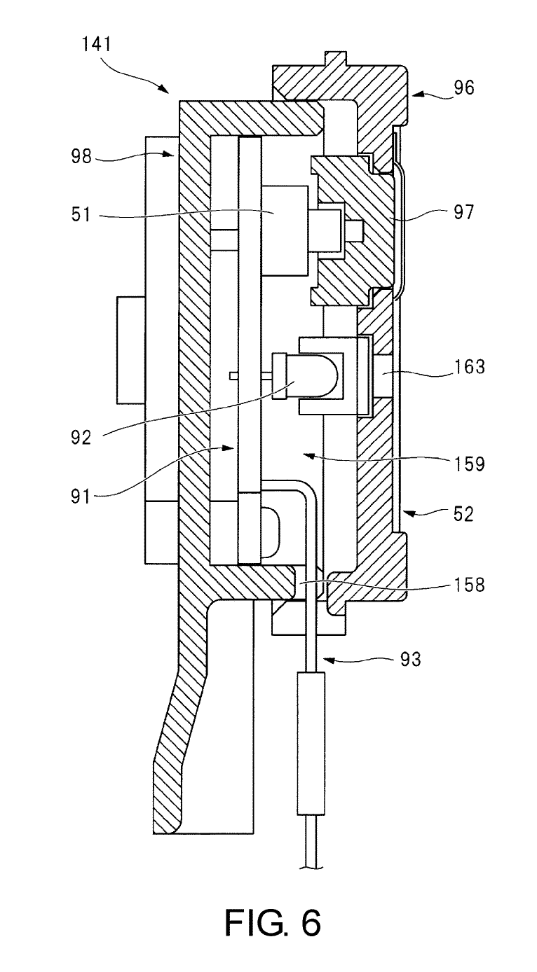

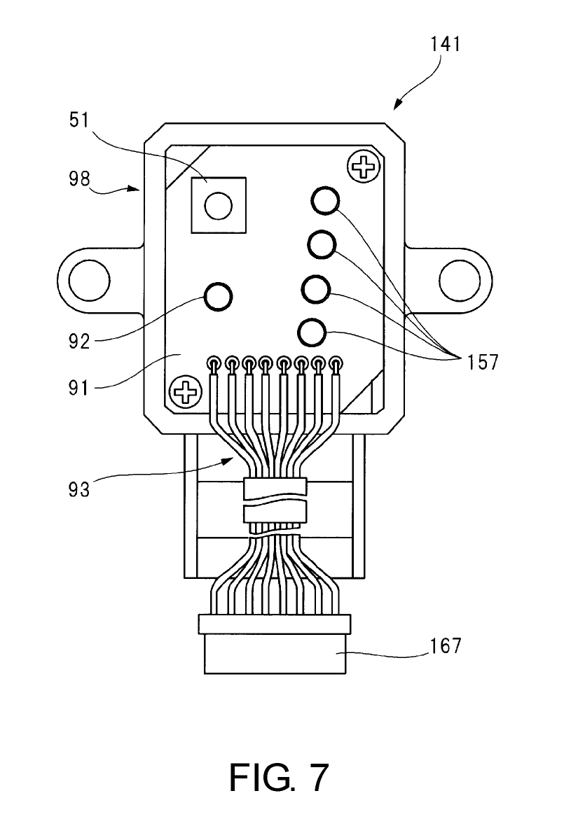

A powered working machine in Embodiment 1 of the disclosure will be described with reference to FIG. 1 to FIG. 7. An electric working machine 10 serving as the powered working machine is also referred to as a hammer drill. The electric working machine 10 is used to perform drilling or the like on a target such as concrete, a stone material, or the like.

The electric working machine 10 includes a working machine main body 12, and the working machine main body 12 is assembled by fixing a cylinder housing 13, an intermediate case 14, a handle 15, a motor housing 20 and a bottom cover 17 to each other. The bottom cover 17 is fixed to the motor housing 20 by a screw member 162. The bottom cover 17 is disposed adjacent to the motor housing 20 in a direction along an axis B1. Vent holes 17a passing through the bottom cover 17 are provided.

The cylinder housing 13 is formed in a cylindrical shape, and a cylinder 18 having a cylindrical shape is installed in the cylinder housing 13. The cylinder 18 is disposed about an axis A1, and a tool holder 19 having a cylindrical shape is formed concentrically with the cylinder 18. The tool holder 19 is installed in the cylinder housing 13, and the tool holder 19 is rotatably supported by a bearing 16. The cylinder 18 and the tool holder 19 are integrally rotatably connected to each other. A tip tool 11 is attached to the tool holder 19, and a rotating force of the cylinder 18 is transmitted to the tip tool 11.

An intermediate striking element 21 formed of a metal is installed from the inside of the tool holder 19 to the inside of the cylinder 18. The intermediate striking element 21 reciprocates in a direction along the axis A1. A striking element 22 configured to strike the intermediate striking element 21 is installed in the cylinder 18. The striking element 22 is reciprocates in the direction along the axis A1. In addition, a piston 23 is disposed in the cylinder 18, and the piston 23 reciprocates in the direction along the axis A1. In the cylinder 18, an air chamber 24 is installed between the striking element 22 and the piston 23.

The intermediate case 14 is disposed between the handle 15 and the cylinder housing 13 in the direction along the axis A1. The motor housing 20 is fixed to the cylinder housing 13 and the intermediate case 14. A disposition range of the motor housing 20 in the direction along the axis A1 overlaps a disposition range of the intermediate case 14 in the direction along the axis A1. The handle 15 is curved in an arch shape, and both ends of the handle 15 are attached to the intermediate case 14. A trigger 132 and a feed cable 25 are installed at the handle 15. In addition, a trigger switch 26 is installed at the handle 15. When a worker operates the trigger 132, the trigger switch 26 is turned on and off.

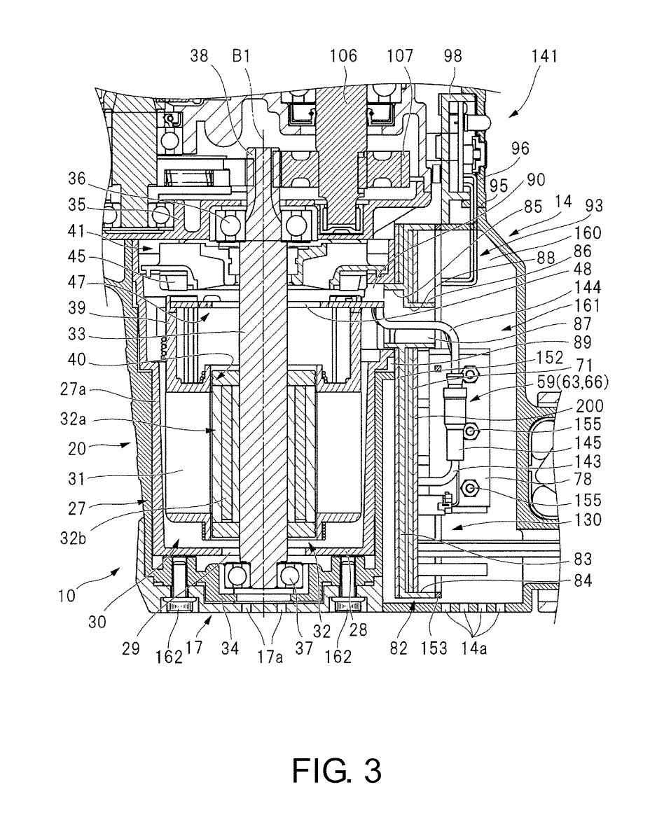

The motor housing 20 is integrally formed of a conductive metal material, for example, aluminum. The motor housing 20 is formed in a cylindrical shape, and a motor case 27 is disposed in the motor housing 20. The motor case 27 is integrally formed of an insulating material, for example, a synthetic resin. As shown in FIG. 3, the motor case 27 has a cylindrical section 27a, and the cylindrical section 27a of the motor case 27 is press-fitted and fixed into the motor housing 20. The motor case 27 has a bottom section 28 continuous with the cylindrical section 27a, and an axial hole 29 is formed in the bottom section 28. The inside of motor case 27 is in communication with the outside of the working machine main body 12 via the axial hole 29 and the vent holes 17a.

In addition, a brushless motor 30 is accommodated in the motor case 27. The brushless motor 30 is a direct current electric motor, and the brushless motor 30 has a stator 31 having a cylindrical shape, and a rotor 32 disposed inside the stator 31. The rotor 32 includes an output shaft 33 and a rotor core 32a fixed to the output shaft 33. When seen in a front view of the electric working machine 10, the axis B1 serving as a rotation center of the output shaft 33 crosses, specifically, is substantially perpendicular to, the axis A1. The motor housing 20 is disposed between the bottom cover 17 and the cylinder housing 13 in the direction along the axis B1. The motor housing 20 includes a bearing support section 34 disposed in the bottom cover 17. The intermediate case 14 includes a partition wall 35 extending to the inside of the cylinder housing 13, and a bearing 36 supported by the partition wall 35 and a bearing 37 supported by the bearing support section 34 are installed therein. The two bearings 36 and 37 are disposed at different positions in the direction along the axis B1 of the output shaft 33. A first end portion of the output shaft 33 is disposed in the axial hole 29, and a second end portion of the output shaft 33 is disposed in the intermediate case 14. A driving gear 38 is installed on an outer circumferential surface of a place of the output shaft 33 disposed in the intermediate case 14.

An insulator 39 is installed in the motor case 27. The insulator 39 is disposed between the brushless motor 30 and the bearing 36 in the direction along the axis B1. The insulator 39 has an axial hole 40, and the output shaft 33 is disposed in the axial hole 40. The insulator 39 is formed of a synthetic resin and installed in the motor case 27 not to be rotated. The insulator 39 is fixed to the stator 31.

A fan 41 is installed between the insulator 39 and the bearing 36 in the motor case 27. The fan 41 is fixed to the output shaft 33, and the fan 41 is rotated with the output shaft 33 to introduce air outside the working machine main body 12 into the working machine main body 12. The outside of the working machine main body 12 and the inside of the intermediate case 14 are in communication with each other via vent holes 14a.

A structure of the fan 41 configured to cool the brushless motor 30 will be described with reference to FIG. 3. The fan 41 is formed in an annular shape, and the fan 41 is attached to the output shaft 33. That is, the fan 41 is rotated with the output shaft 33. The fan 41 is formed of a synthetic resin serving as a non-magnetic material, and a permanent magnet 45 is attached to the fan 41. The permanent magnet 45 is an annular body centered on the axis B1, and N poles and S poles having different magnetic poles are alternately disposed in a circumferential direction of the permanent magnet 45.

A connecting board 47 is installed in the motor case 27. The connecting board 47 is fixed to, for example, the insulator 39. That is, the connecting board 47 is attached to the stator 31 via the insulator 39. The connecting board 47 is disposed between the stator 31 and the permanent magnet 45 attached to the fan 41 in the direction along the axis B1. A hole 48 passing through the connecting board 47 in a thickness direction is provided, and the output shaft 33 is disposed in the hole 48. The connecting board 47 is formed of a non-magnetic material, for example, a synthetic resin, and magnetic sensors S1 to S3 are attached to the connecting board 47.

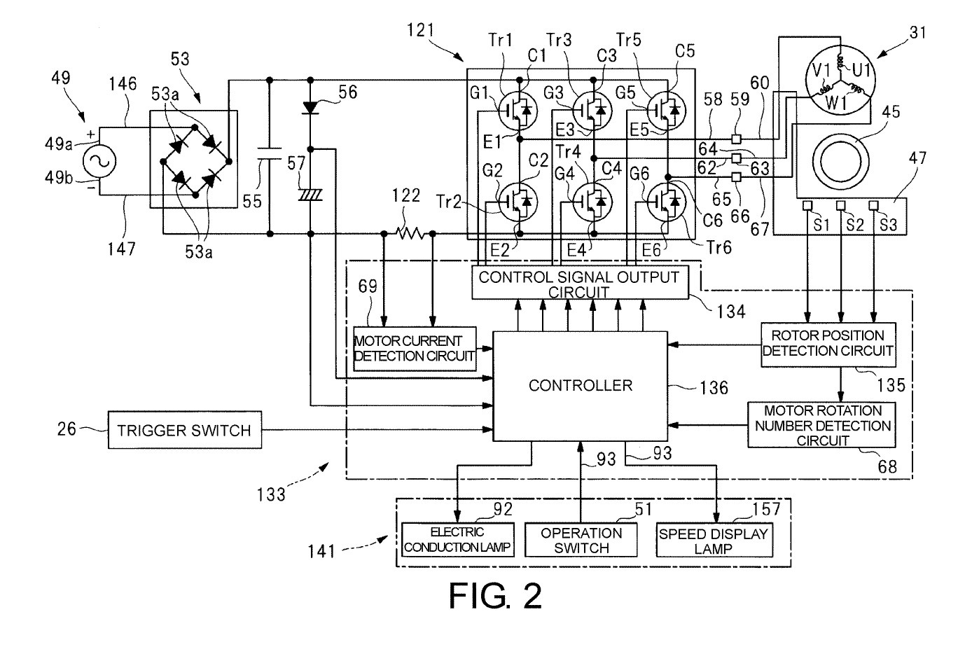

FIG. 2 shows a control circuit configured to control the electric working machine 10. The brushless motor 30 includes a commercial power supply 49 serving as a power supply, and power of the commercial power supply 49 flows to a coil of the brushless motor 30 via the feed cable 25.

In addition, the stator 31 of the brushless motor 30 includes coils U1, V1 and W1 corresponding to a U phase, a V phase and a W phase, four permanent magnets 32b having two different polarities are installed at the rotor core 32a at intervals in the circumferential direction, and the permanent magnets 32b having different polarities are alternately arranged. The three magnetic sensors S1 to S3 output detection signals representing a rotation position of the rotor 32. The three magnetic sensors S1 to S3 are installed to correspond to the three-phase coils U1, V1 and W1. The magnetic sensors S1 to S3 are non-contact sensors configured to detect a magnetic force generated by the permanent magnet 45 attached to the fan 41 and convert the magnetic force into an electric signal to output the electric signal. Hall elements can be used as the magnetic sensors S1 to S3.

The electric working machine 10 has an inverter circuit 121 configured to control current supplied to the coils U1, V1 and W1. A rectifier circuit 53 configured to rectify alternating current of the commercial power supply 49 into direct current is installed at an electric circuit between the commercial power supply 49 and the inverter circuit 121. The rectifier circuit 53 is constituted by bridge-connecting a plurality of diodes 53a. In addition, a smoothing capacitor 55 is installed between the rectifier circuit 53 and the inverter circuit 121. The smoothing capacitor 55 smooths a voltage rectified from alternating current into direct current by the rectifier circuit 53. In addition, a diode 56 and a capacitor 57 are installed between the inverter circuit 121 and the smoothing capacitor 55. The diode 56 and the capacitor 57 are disposed in series. The diode 56 and the capacitor 57 serve as a power supply circuit configured to supply power of the commercial power supply 49 to a controller 136, and the feed cable 25 is connected to the commercial power supply 49 to stabilize the voltage applied from the commercial power supply 49 to the controller 136.

The inverter circuit 121 is a 3-phase full bridge inverter circuit and has switching elements Tr1 to Tr6. Each of the switching elements Tr1 to Tr6 is an insulated gate bipolar transistor (IGBT). The switching element Tr1 includes a collector C1, a gate G1 and an emitter E1. The switching element Tr2 includes a collector C2, a gate G2 and an emitter E2. The switching element Tr3 includes a collector C3, a gate G3 and an emitter E3. The switching element Tr4 includes a collector C4, a gate G4 and an emitter E4. The switching element Tr5 includes a collector C5, a gate G5 and an emitter E5. The switching element Tr6 includes a collector C6, a gate G6 and an emitter E6. The collectors C1, C3 and C5 are connected to a positive electrode 49a of the commercial power supply 49, and the collectors C1, C3 and C5 are connected to each other in parallel. That is, the collectors C1, C3 and C5 are high sides.

In addition, the emitter E1 and the collector C2 are connected to each other in parallel and connected to a lead wire 58. In addition, the emitter E3 and the collector C4 are connected to each other in parallel and connected to a lead wire 62. Further, the emitter E5 and the collector C6 are connected to each other in parallel and connected to a lead wire 65. Further, a voltage serving as a control signal is applied to the gates G1 to G6. Further, the emitters E2, E4 and E6 are connected to a negative electrode 49b of the commercial power supply 49, and the emitters E2, E4 and E6 are connected to each other in parallel. That is, the emitters E2, E4 and E6 are low sides.

In addition, a lead wire 60 connected to the coil U1 is provided, and a connector 59 configured to connect the lead wire 58 and the lead wire 60 is provided. A lead wire 64 connected to the coil V1 is provided, and a connector 63 configured to connect the lead wire 62 and the lead wire 64 is provided. A lead wire 67 connected to the coil W1 is provided, and a connector 66 configured to connect the lead wire 67 and the lead wire 65 is provided.

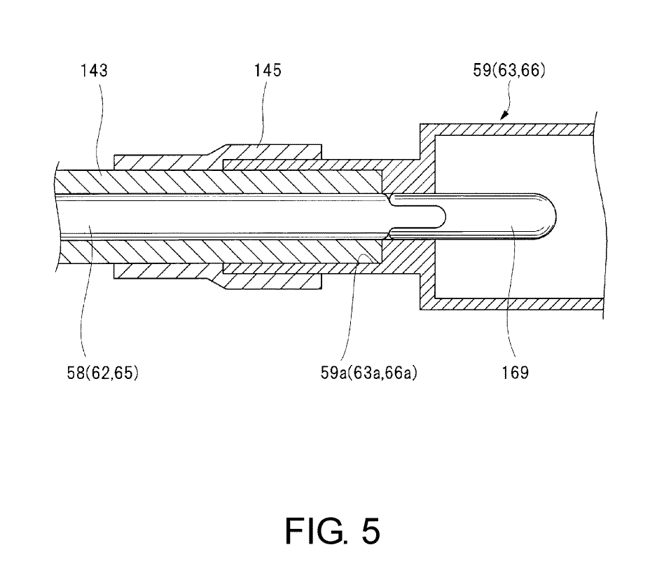

As shown in FIG. 5, the lead wires 58, 62 and 65 are covered by protective tubes 143. The lead wire 58 is connected to an insertion hole 59a of the connector 59, the lead wire 62 is inserted into an insertion hole 63a of the connector 63, and the lead wire 65 is inserted into an insertion hole 66a of the connector 66. The lead wires 60, 64 and 67 are covered by the protective tubes 143.

Further, heat shrinkable tubes 145 configured to cover connecting places of the connectors 59, 63 and 66 and the protective tubes 143 are provided. The protective tubes 143 are formed of an insulating material, for example, a silicone rubber. The heat shrinkable tubes 145 are formed of, for example, a polyolefin. The heat shrinkable tubes 145 prevent the protective tubes 143 from being removed from the insertion holes 59a, 63a and 66a of the connectors 59, 63 and 66. Conductive plugs 169 are attached to end portions of each of the lead wires 58, 62 and 65, and the plugs 169 are disposed in each of the connectors 59, 63 and 66. The connectors 59, 63 and 66, the plug 169 and the lead wires 60, 64 and 67 are pressurized and caulked from the outside in the radial direction, and the plugs 169 are fixed to the lead wires 58, 62 and 65. The plugs 169 are connected to each of the lead wires 60, 64 and 67.

In addition, lead wires 146 and 147 configured to connect a control board 71 and the feed cable 25 are covered with protective tubes 148. The lead wires 146 and 147 and the feed cable 25 can also be connected using connectors and heat shrinkable tubes as described above.

Then, commutation operations with respect to the coils U1, V1 and W1 are controlled by controlling timing of turning on and off control signals input into the gates G1 to G6 of the switching elements Tr1 to Tr6 and a duration in which an on state is maintained, i.e., a duty ratio.

A motor control unit 133 calculates a control signal configured to control the inverter circuit 121 and outputs the control signal. The motor control unit 133 includes the controller 136, a control signal output circuit 134, a rotor position detection circuit 135, a motor revolution number detection circuit 68 and a motor current detection circuit 69. Detection signals of the magnetic sensors S1 to S3 are delivered to the rotor position detection circuit 135. The rotor position detection circuit 135 detects a rotation position of the rotor 32.

The rotor position detection circuit 135 processes a signal representing the rotation position of the rotor 32. The signal output from the rotor position detection circuit 135 is delivered to the controller 136 and the motor revolution number detection circuit 68. The motor revolution number detection circuit 68 detects a motor revolution number, and the signal output from the motor revolution number detection circuit 68 is input into the controller 136.

The motor current detection circuit 69 is connected to both ends of a current detection resistor 122, and the motor current detection circuit 69 detects a current value flowing to the brushless motor 30. The signal output from the motor current detection circuit 69 is input into the controller 136. The controller 136 includes a micro processor configured to process the control signal and a memory, and a control program, an arithmetic expression, data, and so on, are stored in the memory. The controller 136 processes the signal input from the motor revolution number detection circuit 68 and calculates an actual rotation speed of the rotor 32. The signal output from the controller 136 is input into the control signal output circuit 134, and the inverter circuit 121 is controlled by the control signal input from the control signal output circuit 134.

The control board 71 to which the rectifier circuit 53, the smoothing capacitor 55, the diode 56, the capacitor 57, the inverter circuit 121, the current detection resistor 122 and the controller 136 are attached is installed in the working machine main body 12. The control board 71 is disposed outside the motor housing 20 and inside the intermediate case 14. The control board 71 is disposed outside the motor housing 20 in the radial direction about the axis B1. The control board 71 is disposed between the motor housing 20 and the handle 15 in the direction along the axis A1. A thickness direction of the control board 71 is equal to the radial direction about the axis B.

The control board 71 is integrally formed of an insulating material, for example, a synthetic resin. A disposition range of the control board 71 in the direction along the axis B1 overlaps a disposition range of the motor housing 20 in the direction along the axis B1. Further, signal lines 75 configured to deliver signals of the magnetic sensors S1 to S3 to the rotor position detection circuit 135 are provided.

The switching elements Tr1 to Tr6 have three terminals connected to each of the collector, the emitter and the gate, and the three terminals are fixed to the control board 71. The switching elements Tr1, Tr3 and Tr5 are disposed in a row, and the switching elements Tr2, Tr4 and Tr6 are disposed in a row. In addition, the switching elements Tr1, Tr3 and Tr5 and the switching elements Tr2, Tr4 and Tr6 are disposed in parallel. Then, one heat sink 78 in contact with the switching elements Tr1, Tr3 and Tr5 is provided. The one heat sink 78 is fixed to the switching elements Tr1, Tr3 and Tr5 by a screw member 155.

In addition, a heat sink 79 in contact with the switching element Tr2, a heat sink 80 in contact with the switching element Tr4 and a heat sink 81 in contact with the switching element Tr6 are provided. The heat sink 79 is fixed to the switching element Tr2 by the screw member 155, the heat sink 80 is fixed to the switching element Tr4 by the screw member 155 and the heat sink 81 is fixed to the switching element Tr6 by the screw member 155. The heat sinks 78 to 81 are formed of a metal having thermal conductivity, for example, aluminum or copper. The heat sinks 78 to 81 cool the switching elements Tr1 to Tr6 by transferring heat of the switching elements Tr1 to Tr6 to air.

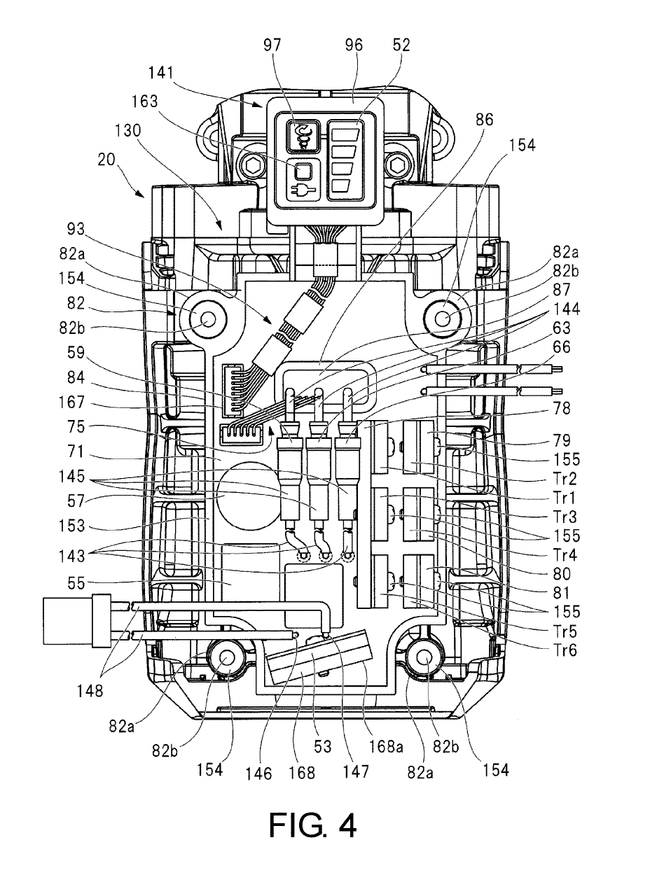

As shown in FIG. 4, a heat sink 168 is attached to the rectifier circuit 53. A surface 168a of the heat sink 168 is planar and the surface 168a is inclined with respect to the axis B1. The surface 168a is inclined in a direction close to the switching element Tr5.

Further, a board case 82 is installed at a side portion of the brushless motor 30 in the radial direction about the axis B1. The board case 82 is disposed outside the motor housing 20. The board case 82 is fixed to the motor housing 20 using a screw member. The control board 71 is attached to the board case 82. An accommodating chamber 161 is formed between the board case 82 and a cover 160 installed at the intermediate case 14. The board case 82 is disposed in the accommodating chamber 161. The board case 82 is formed in a tray shape having a plate section 83 disposed parallel to the axis B1 and a sidewall 84 formed at an outer circumferential edge of the plate section 83. The sidewall 84 protrudes in a direction away from the motor housing 20 and the direction along the axis A1. The board case 82 is integrally formed of an insulating material, for example, a synthetic resin. The plate section 83 is disposed between the motor housing 20 and the control board 71 in the direction along the axis A1. The board case 82 includes a plurality of boss sections 82a formed outside the sidewall 84, and screw members are inserted into holes 82b of the boss sections 82a.

The control hoard 71 is disposed in a space surrounded by the sidewall 84, and the control board 71 is parallel to the plate section 83. Cylindrical sections 85 and 86 continuous with the plate section 83 are provided, and passages 87 are formed in the cylindrical sections 85 and 86. A hole portion 90 passing through the motor case 27 is provided, and a hole portion 89 passing through the motor housing 20 is provided. The cylindrical section 85 is disposed in the hole portions 89 and 90. A hole 88 passing through the control board 71 in the thickness direction is provided, and the cylindrical section 86 is disposed in the hole 88. The accommodating chamber 161 is formed between the board case 82 and the cover 160. The passage 87 brings the inside of the motor case 27 in communication with the accommodating chamber 161. Then, the lead wires 60, 64 and 67 and the signal line 75 pass through the passage 87.

Further, the cover 60 configured to cover the board case 82 is installed at the intermediate case 14. The intermediate case 14 and the motor housing 20 are fixed to each other, the cover 160 covers the board case 82 and the accommodating chamber 161 is formed between the cover 160 and the board case 82. A control unit 130 is constituted by the board case 82 and the control board 71 to which electric parts are attached.

In a process of assembling the control unit 130, a resin flows to the board case 82 and the resin is solidified in a state in which the control board 71 is received in the board case 82, and a resin layer 200 is formed. The resin layer 200 covers the entire surface of the control board 71 and is attached to the surface of the control board 71. The resin layer 200 has waterproof and dustproof functions with respect to the control unit 130. Further, in FIG. 4, the resin layer 200 is omitted for convenience of illustration. Electric parts are elements configured to control a revolution number, a rotation speed, a torque and a rotation direction of the brushless motor 30, and the electric parts include the rectifier circuit 53, the switching elements Tr1 to Tr6, the smoothing capacitor 55, the diode 56, the capacitor 57, the current detection resistor 122 and the controller 136.

Further, a display plate case 141 is installed in the intermediate case 14. The display plate case 141 is disposed outside the accommodating chamber 161. A disposition region of the display plate case 141 is different from a disposition region of the control unit 130 in the direction along the axis B1. The display plate case 141 includes a board holder 98 fixed to the partition wall in the cylinder housing 13, and a cover 96 configured to cover an operation board 91 attached to the board holder 98. An accommodating chamber 159 is formed by the cover 96 and the board holder 98, and a gap between the cover 96 and the board holder 98 is sealed by a seal material, for example, resin coating or silicon rubber. The operation board 91 is installed in the accommodating chamber 159. An operation switch 51, an electric conduction lamp 92 configured to display whether power is supplied, and a speed display lamp 157 are installed on the operation board 91. Both of the electric conduction lamp 92 and the speed display lamp 157 are LED lamps. The operation board 91 is held at the intermediate case 14 via the board holder 98.

An electric wire 93 configured to connect the operation board 91 and the control board 71 is provided. An opening section 158 is installed between the board holder 98 and the cover 96, and the electric wire 93 passes through the opening section 158. A socket section 167 configured to connect the electric wire 93 and the control board 71 is provided. The opening section 158 brings the inside of the control unit 130 in communication with the accommodating chamber 159 of the display plate case 141. A window section 95 is opened to the intermediate case 14, and the cover 96 is disposed on the window section 95.

An operation button 97 is attached to the cover 96, and when a worker operates the operation button 97, the operation switch 51 is operated, an operation signal of the operation switch 51 is input into the controller 136, and the controller 136 switches a target rotation speed. The target rotation speed can be switched by, for example, four stages, and four speed display lamps are provided. In addition, the cover 96 includes a speed display section 52 configured to display stages of the target rotation speed of the brushless motor 30, and an electric conduction display section 163. The cover 96 is integrally formed of a synthetic resin and has optical transparency. For this reason, a worker can visually recognize light of the electric conduction lamp 92 and the speed display lamp 157 from the outside of the display plate case 141. The speed display lamp 157 corresponding to a selected target rotation speed is turned on, and the speed display lamp 157 corresponding to a non-selected target rotation speed is turned off. In addition, when the feed cable 25 is connected to the commercial power supply 49, the electric conduction lamp 92 is turned on, and when the feed cable 25 is cutoff from the commercial power supply 49, the electric conduction lamp 92 is turned off.

A power conversion mechanism 120 configured to convert a rotating force of the output shaft 33 of the brushless motor 30 into a reciprocal moving force of the piston 23 will be described. First, a crankshaft 106 is rotatably installed in the intermediate case 14. The crankshaft 106 is parallel to the output shaft 33, and a driven gear 107 installed on the crankshaft 106 is meshed with the driving gear 38. A crank pin 108 eccentric from a rotation center of the crankshaft 106 is attached to the crankshaft 106.

In addition, a connecting rod 109 configured to connect the crank pin 108 and the piston 23 to enable power transmission is provided. Then, when a rotating force of the output shaft 33 is transmitted to the crankshaft 106 and the crank pin 108 revolves, the piston 23 reciprocates in the cylinder 18. The power conversion mechanism 120 is constituted by the crankshaft 106, the crank pin 108 and the connecting rod 109.

Next, a mechanism of converting a rotating force of the output shaft 33 into a rotating force of the cylinder 18 will be described. A rotating force transmission shaft 110 is rotatably installed in the cylinder housing 13, and a driven gear 111 is installed on the rotating force transmission shaft 110. The driven gear 111 is meshed with the driving gear 38. The rotating force transmission shaft 110 is rotatably supported by bearings 113 and 114. For this reason, the rotating force of the output shaft 33 is transmitted to the rotating force transmission shaft 110. Further, a bevel gear 115 is installed on the rotating force transmission shaft 110.

Meanwhile, a bevel gear 116 having a cylindrical shape is attached to an outer circumference of the cylinder 18, and the bevel gear 116 is rotatable with respect to the cylinder 18. The bevel gear 116 is meshed with the bevel gear 115. A sleeve 117 rotated integrally with the cylinder 18 and movable in the direction along the axis A1 is attached to the outer circumference of the cylinder 18. The electric working machine 10 includes a mode switching dial 123, and when a worker operates the mode switching dial 123, the sleeve 117 moves in the direction along the axis A1. In addition, a clutch mechanism configured to engage the sleeve 117 with the bevel gear 116 or release the engagement is provided.

When the sleeve 117 is moved along the axis A1 with respect to the cylinder 18, the sleeve 117 is engaged with the bevel gear 116 to enable power transmission, or the sleeve 117 is released from the bevel gear 116. When the sleeve 117 is engaged with the bevel gear 116, a rotating force of the rotating force transmission shaft 110 is transmitted to the cylinder 18. On the other hand, when the sleeve 117 is released from the bevel gear 116, the rotating force of the rotating force transmission shaft 110 is not transmitted to the cylinder 18.

A use example of the electric working machine 10 will be described. When a worker operates the trigger 132 and the trigger switch 26 is turned on or off, a signal output from the trigger switch is delivered to the controller 136. When the on signal of the trigger switch is input into the controller 136, a control signal output from the control signal output circuit 134 is input into the inverter circuit 121, the switching elements Tr1 to Tr6 are individually turned on and off, and current sequentially flows to the coils U1, V1 and W1. Then, the coils U1, V1 and W1 cooperate with the permanent magnets 32b to form a rotating magnetic field, and the rotor 32 of the brushless motor 30 is rotated.

The controller 136 performs control to bring an actual rotation speed of the rotor 32 closer to a target rotation speed. The actual rotation speed of the rotor 32 is controlled by adjusting voltages applied to the coils U1, V1 and W1. Specifically, the control is performed by adjusting a duty ratio of the on signal applied to the gates G1 to G6 of the switching elements Tr1 to Tr6 of the inverter circuit 121. When the rotor 32 of the brushless motor 30 is rotated, a rotating force of the output shaft 33 is converted into a reciprocal moving force of the piston 23 by the power conversion mechanism 120, and the piston 23 reciprocates in the cylinder 18.

When the piston 23 is operated in a direction close to the crankshaft 106, a pressure of the air chamber 24 is decreased, and the striking element 22 is moved in a direction away from the intermediate striking element 21. When the striking element 22 moves in a direction away from the intermediate striking element 21, no air is suctioned into the air chamber 24. In addition, after the piston 23 reaches a top dead center, the piston 23 is moved from the top dead center to a bottom dead center, and the pressure in the air chamber 24 is increased. Then, the striking element 22 strikes the intermediate striking element 21. A striking force applied to the intermediate striking element 21 is transmitted to a target via the tip tool 11. After that, while the output shaft 33 of the brushless motor 30 is rotated, the striking element 22 reciprocates in the cylinder 18, and the striking element 22 intermittently strikes the intermediate striking element 21.

Meanwhile, a rotating force of the output shaft 33 of the brushless motor 30 is transmitted to the rotating force transmission shaft 110 via the driven gear 111. When the mode switching dial 123 is operated and a striking/rotation mode is selected, a rotating force of the rotating force transmission shaft 110 is transmitted to the cylinder 18, and the cylinder 18 is rotated. A rotating force of the cylinder 18 is transmitted to the tip tool 11 via the tool holder 19. In this way, the electric working machine 10 transmits the striking force and the rotating force to the tip tool 11. On the other hand, when the mode switching dial 123 is operated and the striking mode is selected, the rotating force of the rotating force transmission shaft 110 is not transmitted to the cylinder 18.

In addition, the fan 41 is rotated when the output shaft 33 of the brushless motor 30 is rotated, and air outside the working machine main body 12 is suctioned into the motor case 27 through the vent holes 17a and the axial hole 29. Then, heat of the brushless motor 30 is transferred to the air, and the brushless motor 30 is cooled. In addition, the air outside the motor housing 20 is introduced into the intermediate case 14 through the vent holes 14a. For this reason, the air flows along the board case 82 accommodated in the accommodating chamber 161, and heat of the rectifier circuit 53 and the switching elements Tr1 to Tr6 is transferred to the air. Accordingly, an increase in temperature of the rectifier circuit 53 and the switching elements Tr1 to Tr6 is suppressed.

Since the air introduced into the intermediate case 14 is provided in a moving direction along the surface 168a of the heat sink 168, an amount of air in contact with the switching elements Tr1 to Tr6 can be increased as much as possible, and cooling efficiency of the switching elements Tr1 to Tr6 is improved. The air that has taken heat of the rectifier circuit 53 and the switching elements Tr1 to Tr6 is introduced into the motor case 27 through the passage 87. The air suctioned into the motor case 27 by rotation of the fan 41 is ejected into the cylinder housing 13 by the fan 41, and discharged to the outside of the working machine main body 12 through an exhaust port installed at the cylinder housing 13.

In the electric working machine 10 of the embodiment, the piston 23, the striking element 22 and the intermediate striking element 21 are operated in the direction along the axis A1. In addition, a striking force applied to the tip tool 11 is generated in the direction along the axis A1. That is, the working machine main body 12 is vibrated in the direction along the axis A1. A thickness direction of the control board 71 is the same as the direction along the axis A1 and a lengthwise direction of the control board 71 is parallel to the axis B1. When the working machine main body 12 is vibrated in the direction along the axis A1, vibrations are transmitted to the control board 71 in the thickness direction.

The electric working machine 10 of the embodiment includes a vibration suppression mechanism configured to suppress vibrations of the control unit 130 in a direction in which a striking force is applied to the tip tool 11, i.e., the direction along the axis A1. The vibration suppression mechanism includes an elastic body 152 to an elastic body 154 installed in the board case 82. The elastic body 152 is fixed to an outer surface of the plate section 83, and an elastic body 153 is fixed to an edge of the sidewall 84. The elastic body 152 is installed throughout the region of the outer surface of the plate section 83 with the same thickness. In a state in which the board case 82 is attached to the motor housing 20, the elastic body 152 comes in contact with the motor housing 20. Further, the elastic body 154 is fixed to the boss sections 82a. In a state in which the intermediate case 14 and the motor housing 20 are fixed, the elastic body 153 and the elastic body 154 come in contact with the intermediate case 14.

The elastic body 152 to the elastic body 154 are integrally formed of a rubber-like elastic body, and the elastic body 152 to the elastic body 154 are fixed to the board case 82 using double sided tapes. Further, the elastic body 152 to the elastic body 154 may be fixed to the board case 82 using an adhesive agent.

Then, the elastic body 152 and the elastic body 153 are disposed at different positions in the direction along the axis A1. Then, the board case 82 is disposed between the elastic body 152 and the elastic body 153 in the direction along the axis A1. The elastic body 154 may be disposed at the same position as the elastic body 153 in the direction along the axis A1 or may be disposed at a position different from the elastic body 153 in the direction along the axis A1.

In the electric working machine 10 of the embodiment, since the elastic bodies 152 and 153 are installed between the board case 82 and the working machine main body 12 configured to support the board case 82, transmission of vibrations of the working machine main body 12 to the control unit 130 can be suppressed. In particular, when the working machine main body 12 is vibrated in the direction along the axis A1, the elastic bodies 152 and 153 reduce the vibrations. For this reason, transmission of vibrations of the working machine main body 12 to the control unit 130 can be suppressed. Accordingly, vibrations of electric parts attached to the control board 71 can be suppressed.

Further, since the control board 71 can be reinforced by accommodating the control board 71 in the board case 82, distortion of the control board 71 due to vibrations of the working machine main body 12 can be suppressed. For example, a structure in which a working machine main body is assembled by fixing constituent pieces divided into two parts in the direction along the axis A1 to each other will be described. When the control board is supported by being sandwiched between the two-split constituent pieces, it is also considered that the two constituent pieces may be deviated due to vibrations of the working machine main body. As a result of deviation of the two constituent pieces, the control board may be damaged due to occurrence of distortion.

Even in the case in which the working machine main body has a structure in which the control board is supported by being sandwiched between the two-split constituent pieces, when the control board 71 is accommodated in the board case 82 like the embodiment, a force due to deviation of the two constituent pieces is not transmitted to the control board 71, and distortion of the control board 71 can be suppressed. In addition, the resin layer 200 is formed by filling a resin in the board case 82. For this reason, the control board 71 can be protected from dusts or the like while the resin layer 200 absorbs an external force and distortion of the control board 71 can be further suppressed.

Further, since the accommodating chamber 159 that accommodates the operation board 91 is covered by the board holder 98 and the cover 96, intrusion of foreign substances generated in a working site, for example, dirt, processed powder and broken pieces into the accommodating chamber 159 can be prevented. Accordingly, a decrease in visual recognition of the speed display lamp 157 and the electric conduction lamp 92 can be suppressed. In addition, the display plate case 141 may be disposed in a path through which cooling wind flows. Even in this case, since the operation board 91 is closed by the board holder 98 and the cover 96 to have good scalability as described above, even when dusts are suctioned into the working machine main body 12 together with the cooling wind, intrusion of the dusts into the accommodating chamber 159 can be prevented, and a decrease in visual recognition of the display plate case 141 can be prevented.

Further, since the lead wires 58, 62 and 65 connected to the control board 71 are covered by the protective tube 143 and the heat shrinkable tube 145, even when the working machine main body 12 is vibrated, contacts of the lead wires 58, 62 and 65 with surrounding objects, for example, the heat sink 78 can be avoided, and disconnection of the lead wires 58, 62 and 65 can be prevented.

Describing correspondence between the configuration of the electric working machine 10 of Embodiment 1 and the configuration of the disclosure, the brushless motor 30 corresponds to a motor of the disclosure, the tip tool 11 corresponds to a working tool of the disclosure, the electric working machine 10 corresponds to a powered working machine of the disclosure, the control board 71 corresponds to a control board of the disclosure, the board case 82 corresponds to a board case of the disclosure, the working machine main body 12 and the motor housing 20 correspond to a housing of the disclosure, the axis A1 corresponds to a first axis of the disclosure, and the axis B1 corresponds to a second axis of the disclosure.

In addition, the elastic bodies 152, 153 and 154 correspond to elastic bodies of the disclosure, the elastic body 152 corresponds to a first elastic body of the disclosure, the elastic body 153 corresponds to a second elastic body of the disclosure, and the elastic body 154 corresponds to a third elastic body of the disclosure. The intermediate striking element 21, the striking element 22 and the piston 23 correspond to a striking mechanism of the disclosure, the motor housing 20 corresponds to a first housing of the disclosure, and the intermediate case 14 corresponds to a second housing of the disclosure. The plate section 83 corresponds to a plate section of the disclosure, the sidewall 84 corresponds to a sidewall of the disclosure, the boss sections 82a corresponds to a boss section of the disclosure, the output shaft 33 corresponds to an output shag of the disclosure, and the resin layer 200 corresponds to a resin layer of the disclosure.

### Embodiment 2

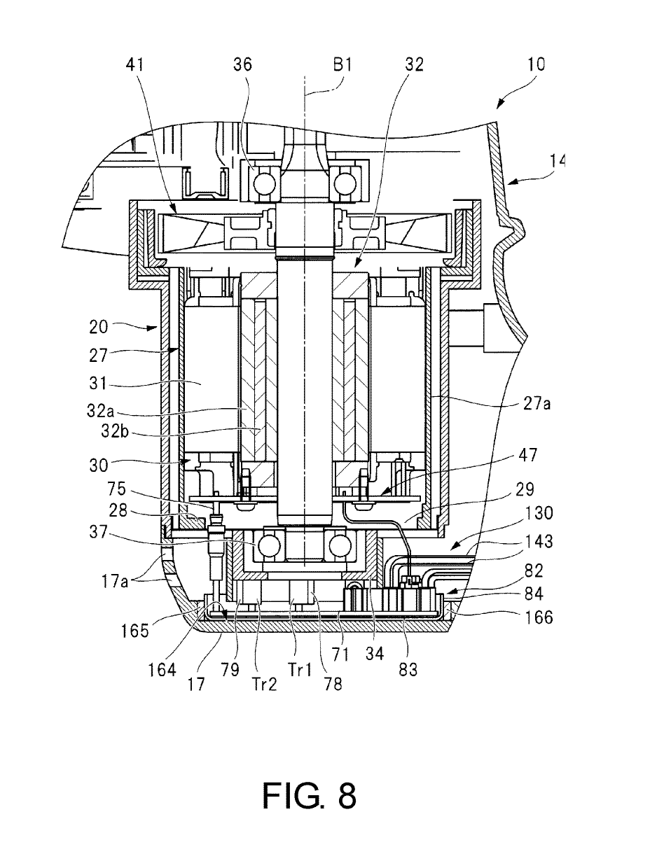

A powered working machine in Embodiment 2 of the disclosure will be described with reference to FIG. 8. Comparing FIG. 8 with FIG. 1, a disposition position of the control unit 130 of the electric working machine 10 differs. The electric working machine 10 shown in FIG. 8 uses the control circuit of FIG. 2. The control unit 130 shown in FIG. 8 is disposed between the brushless motor 30 and the bottom cover 17 in the direction along the axis B1. The cover 160 shown in FIG. 3 is not provided in FIG. 8. In addition, the control board 71 is disposed in a direction crossing the axis B1 when seen in a front view of the electric working machine 10. A concave section 164 is formed in an inner surface of the bottom cover 17, and the board case 82 is disposed in the concave section 164. The plate section 83 comes in contact with a bottom surface of the concave section 164.

Then, elastic bodies 165 and 166 are installed between an inner circumferential surface of the concave section 164 and the sidewall 84. The elastic bodies 165 and 166 are disposed at different positions in the direction along the axis A1. The elastic bodies 165 and 166 are disposed at both sides of the board case 82 in the direction along the axis A1. The elastic bodies 165 and 166 are interposed between the board case 82 and the bottom cover 17. The elastic bodies 165 and 166 are formed of the same material as the elastic bodies 152, 153 and 154. The elastic bodies 165 and 166 may be fixed to the board case 82 or may be fixed to an inner circumferential surface of the concave section 164. In addition, the elastic body may be installed between the plate section 83 and the concave section 164, and in this case, transmission of vibrations in the direction along the output shaft 33 to the control board 71 via the board case 82 can be suppressed.

In addition, in FIG. 8, the connecting board 47 is fixed to the stator 31. The magnetic sensors S1 to S3 installed on the connecting board 47 detect a magnetic force generated by the permanent magnets 32b of the rotor 32 and output a signal. In FIG. 8, the control board 71 and the signal line 75 can also be connected using the connector, the heat shrinkable tube and the protective tube shown in FIG. 5.

In the electric working machine 10 of FIG. 8, when the working machine main body 12 in which a striking work is performed is vibrated in the direction perpendicular to the axis B1, i.e., the direction along the axis A1 in FIG. 1, the vibrations are reduced by the elastic bodies 165 and 166. For this reason, vibrations of the control unit 130 in the direction along the axis A1 of FIG. 1 can be suppressed. Further, the same resin layer as the resin layer 200 of FIG. 3 may be formed in the board case 82 shown in FIG. 8. Accordingly, the electric working machine 10 of Embodiment 2 can obtain the same effect as the electric working machine 10 of Embodiment 1. In addition, the elastic bodies 165 and 166 correspond to the elastic body of the disclosure, and the bottom cover 17 corresponds to the housing of the disclosure.

The disclosure is not limited to the embodiment but may be variously modified without departing from the spirit of the disclosure. For example, the elastic bodies serving as the vibration suppression mechanism may be separately formed or all of the elastic bodies may be integrated. The elastic body of the disclosure is a shock absorbing material that reduces vibrations. In addition, the elastic body serving as the vibration suppression mechanism may be interposed between a board case and a motor housing and between a board case and an intermediate case. That is, the elastic body may be fixed to a cover of the motor housing and the intermediate case. Then, when the board case is fixed to the motor housing, the elastic body fixed to the motor housing comes in contact with the board case. In addition, when the intermediate case is fixed to the motor housing, the elastic body installed in the intermediate case comes in contact with the board case.

### Embodiment 3

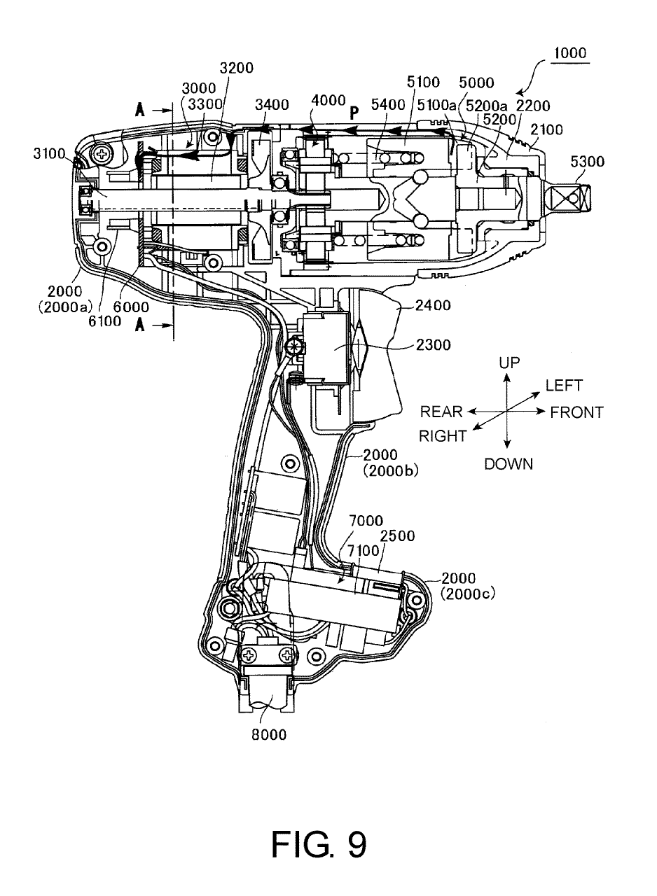

A powered working machine in Embodiment 3 of the disclosure will be described with reference to FIG. 9 to FIG. 14(b). Here, the case in which the disclosure is applied to an impact wrench is exemplarily described.

FIG. 9 is a cross-sectional view showing a configuration of an impact wrench 1000 according to the disclosure. As shown in FIG. 9, the impact wrench 1000 is configured to include a housing 2000, a motor 3000, a gear mechanism 4000, an output section 5000, a circuit board 6000, a control unit 7000 and a power supply cord 8000.

An outer block of the impact wrench 1000 is constituted by the housing 2000 formed of a resin, and a cover 2100 formed of a resin and configured to cover the output section 5000. A hammer case 2200 formed of a metal is accommodated in the cover 2100. The housing 2000 corresponds to a motor accommodating section of the disclosure and is constituted by a trunk section 2000a, a handle section 2000b and a board accommodating section 2000c. The trunk section 2000a is formed in a substantially cylindrical shape, and the motor 3000, the gear mechanism 4000 and the output section 5000 are sequentially accommodated together with the cover 2100 and the hammer case 2200. In the following description, the output section 5000 is defined as a front side and the motor 3000 side is defined as a rear side. In addition, a direction in which the handle section 2000b extends with respect to the trunk section 2000a is defined as downward, and an opposite direction is defined as upward.

A suction port (not shown) configured to suction external air is formed at a rear end surface of the trunk section 2000a of the housing 2000, and an exhaust port (not shown) configured to discharge the external air suctioned into the trunk section 2000a is formed at the trunk section 2000a disposed outside a cooling fan 3400, which will be described below. The motor 3000 and the circuit board 6000 are cooled by the external air.

The handle section 2000b extends downward from a substantially central position of the trunk section 2000a in a forward/rearward direction and is configured integrally with the trunk section 2000a. A switch mechanism 2300 is installed in the handle section 2000b, and the power supply cord 8000 that is able to be connected to a commercial alternating current power supply extends to a tip position in an extension direction thereof. In the handle section 2000b, a trigger 2400 serving as an operation spot of a worker is installed at a front position serving as a root portion from the trunk section 2000a. The trigger 2400 is connected to the switch mechanism 2300 and used to switch supply and cut-off of driving power to the motor 3000 and to switch a rotation direction of the motor 3000. The trigger 2400 of the embodiment is a tumbler switch.

The board accommodating section 2000c protrudes forward from a lower end position of the handle section 2000b and is configured integrally with the handle section 2000h. The control unit 7000 is accommodated in the board accommodating section 2000c. In addition, an operation panel 2500 is installed on the upper surface of the board accommodating section 2000c.

The motor 3000 is a brushless motor, and as shown in FIG. 9, includes an output shaft 3100, the rotor 3200 and a stator 3300. The output shaft 3100 is disposed in the trunk section 2000a such that an axial direction coincides with a forward/rearward direction, protrudes forward and rearward from the rotor 3200, and is rotatably supported at the trunk section 2000a by a bearing at a protruded place thereof. In the output shaft 3100, the cooling fan 3400 rotated concentrically and integrally with the output shaft 3100 is installed at a place protruding forward. The rotor 3200 is fixed to the output shaft 3100 and has a plurality of permanent magnets (not shown). The stator 3300 includes a plurality of coils 3500 and is disposed to surround the rotor 3200. A configuration of the motor 3000 will be described below in detail.

The gear mechanism 4000 is a speed reduction mechanism constituted by a planetary gear mechanism including a plurality of gears, and reduces a rotation speed of the output shaft 3100 to transmit the reduced speed to the output section 5000.

The output section 5000 is configured to include a hammer 5100 and an anvil 5200 disposed in front of the hammer 5100. The hammer 5100 and the anvil 5200 are rotatably disposed. An attachment section 5300 configured to attach a tip tool is installed at a front end of the anvil 5200.

The hammer 5100 includes a colliding section 5100a disposed at a front end thereof, and the anvil 5200 includes a collision section 5200a disposed at a rear end thereof. In addition, the hammer 5100 is biased to a front side of a spring 5400 such that the colliding section 5100a collides with the collision section 5200a in a rotation direction upon rotation. According to the above-mentioned configuration, when the hammer 5100 is rotated, a strike is applied to the anvil 5200.

In addition, the hammer 5100 is configured to resist against a biasing force of the spring 5400 to be movable rearward. Conventionally, since the colliding section 5100a of the hammer 5100 is engaged with the collision section 5200a of the anvil 5200, rotation of the motor 3000 is transmitted to the anvil 5200 via the gear mechanism 4000 and the hammer 5100, and a fastening work of a latch is performed by integrally rotating the hammer 5100 and the anvil 5200 and rotating the tip tool (not shown) attached to the attachment section 5300. Meanwhile, since a load is increased upon termination of fastening of the latch, the hammer 5100 is in a state being locked, and the hammer 5100 and the anvil 5200 cannot be integrally rotated. Then, the hammer 5100 retracts while rotating against a biasing force of the spring 5400. Then, when the colliding section 5100a rides over the collision section 5200a, elastic energy accumulated in the spring 5400 is released, the hammer 5100 moves forward, and the colliding section 5100a collides with the collision section 5200a. According to this repetition, the anvil 5200 is rotated little by little, and a fastening work can be performed even when a load is large.

In the embodiment, the circuit board 6000 is a board in which a switching element 6100 such as a metal oxide semiconductor field effect transistor (MOSFET), an insulated gate bipolar transistor (IGBT), or the like, is mounted. The circuit board 6000 corresponds to a board of the disclosure.

The control unit 7000 includes a control circuit board 7100 accommodated in the board accommodating section 2000c and configured to control the entire impact wrench 1000. The control circuit board 7100 switches a rotation direction of the motor 3000 as the trigger 2400 is operated (pressed) upward or downward about a central portion in an upward/downward direction as a support point. Further, as an amount of electric power supplied to the motor 3000 is adjusted according to an operation amount of the trigger 2400, the trigger 2400 may be configured to control a rotation speed of the motor 3000. As a worker operates the operation panel 2500, an operation speed or the like of the impact wrench 1000 can be set.

The power supply cord 8000 supplies power to each part as the power supply cord 8000 is connected to a commercial alternating current power supply.

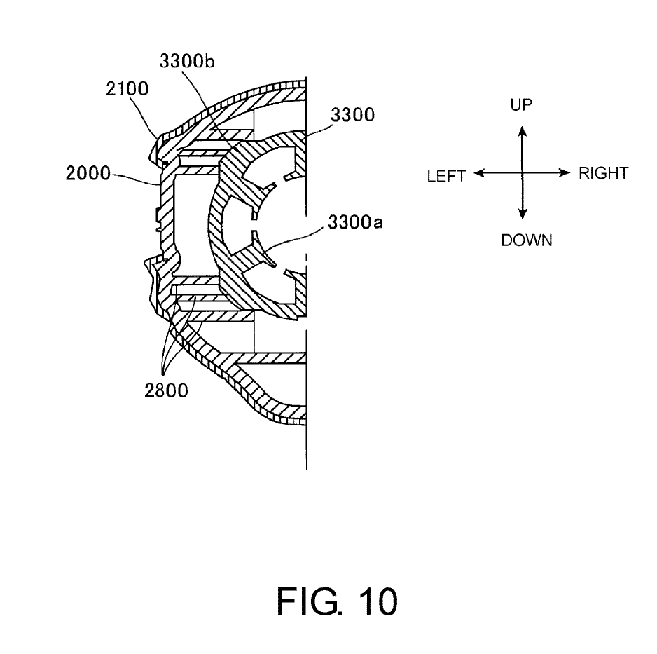

Next, a specific configuration of the motor 3000 in the impact wrench 1000 according to Embodiment 3 will be described. FIG. 10 is a view of a support portion of the motor 3000 in the impact wrench 1000 according to the disclosure, showing a cross-sectional view taken along line A-A of FIG. 9. FIG. 10 shows only a left half of the cross-sectional view. In the following description, an axial direction designates an axial direction of the stator 3300, and a radial direction designates a radial direction of the stator 3300.

The stator 3300 is formed in a substantially cylindrical shape, and as shown in FIG. 10, six protrusions (teeth sections) 3300a parallel to the circumferential direction are formed at an inner circumferential section thereof to protrude inward in the radial direction. In addition, four convex sections 3300b protruding outward in the radial direction are formed in the outer circumferential section of the stator 3300. As a plurality of ribs 2800 protrude in the trunk section 2000a of the housing 2 and the convex sections 3300h of the stator 3300 are supported by the plurality of ribs 2800, the stator 3300 is fixed into the housing 2000.

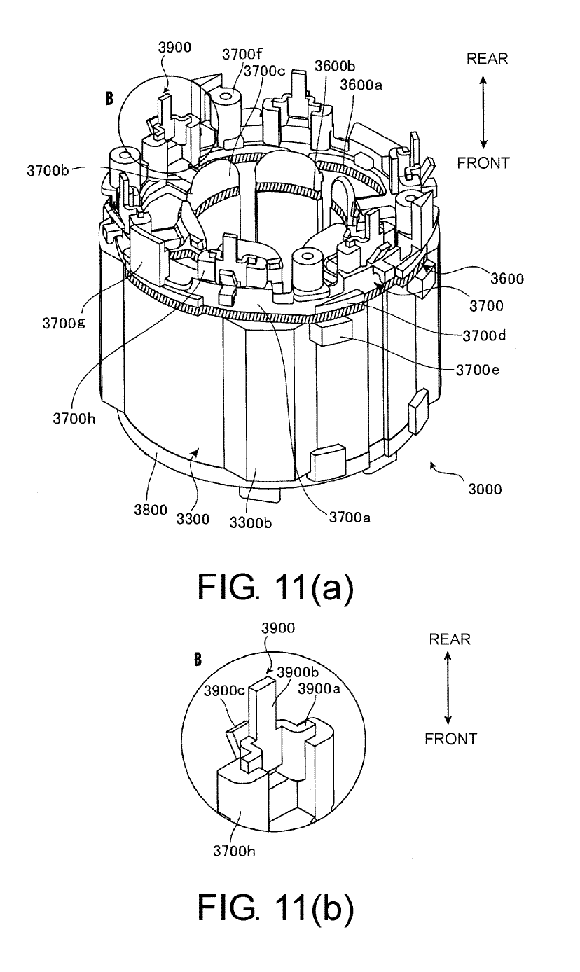

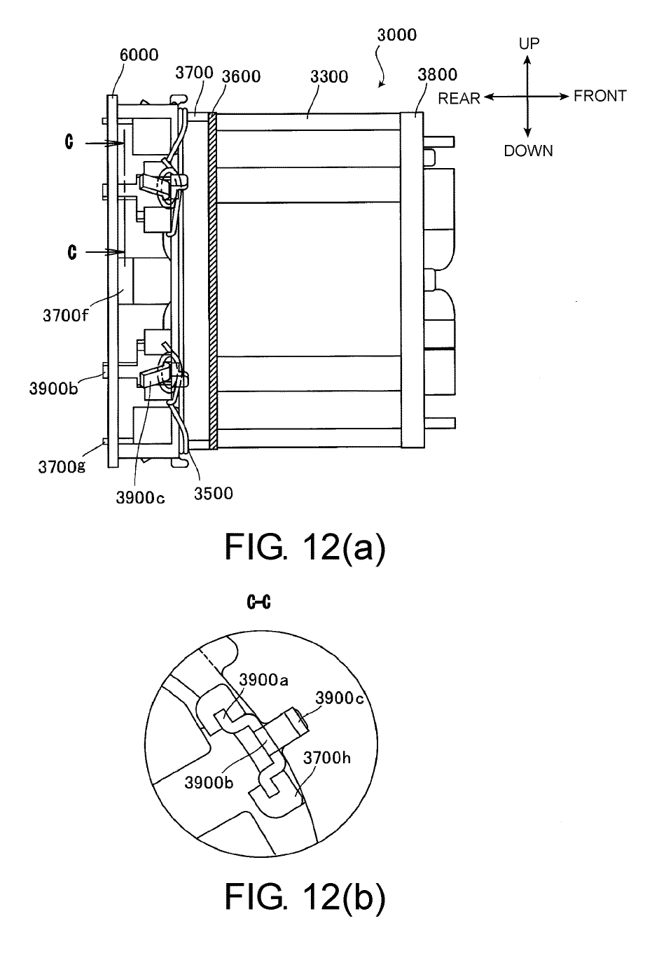

FIG. 11(a) is a perspective view showing a partial configuration of the motor 3000 in the impact wrench 1000 according to Embodiment 3, and FIG. 11(b) is an enlarged view of a portion B of FIG. 11(a), specifically, a partially enlarged view showing an engaging portion of a connector 3900 and an insulator 3700. In addition, FIG. 12(a) and FIG. 12(b) show a side view and a partially enlarged view of a partial configuration of the motor 3000 in the impact wrench 1000 according to Embodiment 3, FIG. 12(a) is a side view of the motor 3000, and FIG. 12(b) is a cross-sectional view taken along line C-C of FIG. 12(a).

As shown in FIG. 11(a), FIG. 11(b) and FIG. 12(a), an anti-vibration rubber 3600 and the insulator 3700 are disposed on a rear surface of the stator 3300 in an axial direction. In addition, an insulator 3800 is also disposed on a front surface of the stator 3300 in the axial direction. The insulator 3700 disposed on the rear surface corresponds to a board support section of the disclosure.

The anti-vibration rubber 3600 is disposed to cover the entire rear surface of the stator 3300 including the protrusions 3300a. That is, the anti-vibration rubber 3600 has a base section 3600a having a substantially cylindrical shape, and six protrusions 3600b disposed parallel to the circumferential direction to protrude inward from the base section 3600a in the radial direction. The base section 3600a is a portion configured to cover a rear surface of the stator 33 having a substantially cylindrical shape, and the protrusions 3600b are portions to cover rear surfaces of the protrusions 3300a of the stator 3300. The anti-vibration rubber 3600 is an example of the elastic body of the disclosure and has a function of absorbing vibrations.

The insulator 3700 is formed of a non-conductive material such as a resin or the like, and insulates the coils 3500 and the stator 3300. The insulator 3700 is disposed to cover the entire rear surface of the stator 3300 in the axial direction covered with the anti-vibration rubber 3600. That is, the anti-vibration rubber 3600 is disposed between the stator 3300 and the insulator 3700. The insulator 3700 has a base section 3700a having a substantially cylindrical shape, six coil winding sections 3700b disposed parallel to the circumferential direction to protrude inward from the base section 3700a in the radial direction, and coil support sections 3700c protruding rearward from end portions of the coil winding sections 3700b in the axial direction. The coils 3500 configured to generate a magnetic flux are wound on the coil winding sections 3700b. The coil support sections 3700c supports the coils 3500 wound on the coil winding sections 3700b.

The insulator 3700 further has a plurality of coil positioning sections 3700d and a plurality of insulator positioning sections 3700e protruding outward from the outer circumferential surface of the base section 3700a in the radial direction. As shown in FIG. 12(a), the coils 3500 extracted from the inside of the stator 3300 are wound on an outer circumferential surface of the insulator 3700. The coil positioning sections 3700d performs positioning of the coils 3500 wound on the outer circumferential surface of the insulator 3700. The insulator positioning sections 3700e perform positioning of the insulator 3700 by abutting the convex sections 3300h formed in the outer circumferential section of the stator 3300 such that the insulator 3700 is not deviated with respect to the stator 3300 in the circumferential direction.

In addition, the insulator 3700 has four board positioning sections 3700f protruding rearward from a rear surface of the base section 3700a in the axial direction and disposed parallel to the circumferential direction, and four board positioning sections 3700g protruding rearward in the axial direction and outward in the radial direction and disposed parallel to the circumferential direction. The board positioning sections 3700f abuts a front surface of the circuit board 6000 in the axial direction, and performs positioning of the circuit board 6000 in the axial direction. In addition, the board positioning sections 3700g protrude further rearward in the axial direction and outward in the radial direction than the board positioning sections 3700f, abut the outer circumferential surface of the circuit board 6000 and perform positioning of the circuit board 6000 in the radial direction.

Further, the insulator 3700 has six connector support sections 3700h formed on a rear surface of the base section 3700a in the axial direction, protruding rearward in the axial direction and parallel to the circumferential direction at substantially equal intervals. The connectors 3900 are engaged with the connector support sections 3700h.

The connector 3900 is formed of a conductive material such as a resin or the like, and as shown in FIG. 11(b) and FIG. 12(b), has an engaging section 3900a engaged with the connector support section 3700h of the insulator 3700, a protrusion 3900b protruding rearward in the axial direction, and an inclined section 3900c inclined in the radial direction. As shown in FIG. 12(a), the protrusion 39b is a portion connected to the circuit board 6000 and protrudes rearward in the axial direction. The inclined section 3900c is a portion, on which the coils 3500 are wound, configured to electrically conduct the connector 3900 and the coils 3500. The connector 3900 corresponds to a board support section of the disclosure.

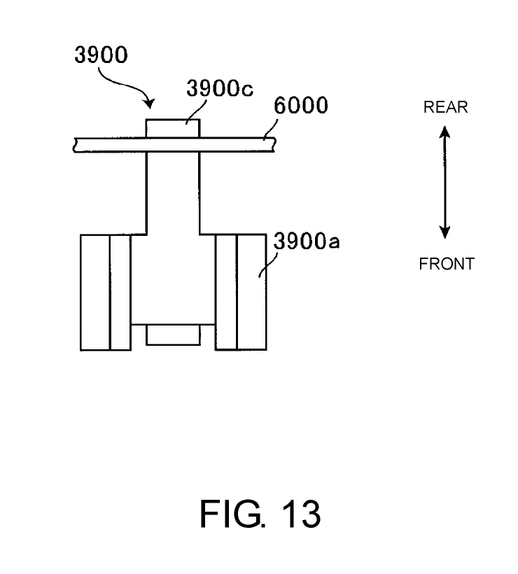

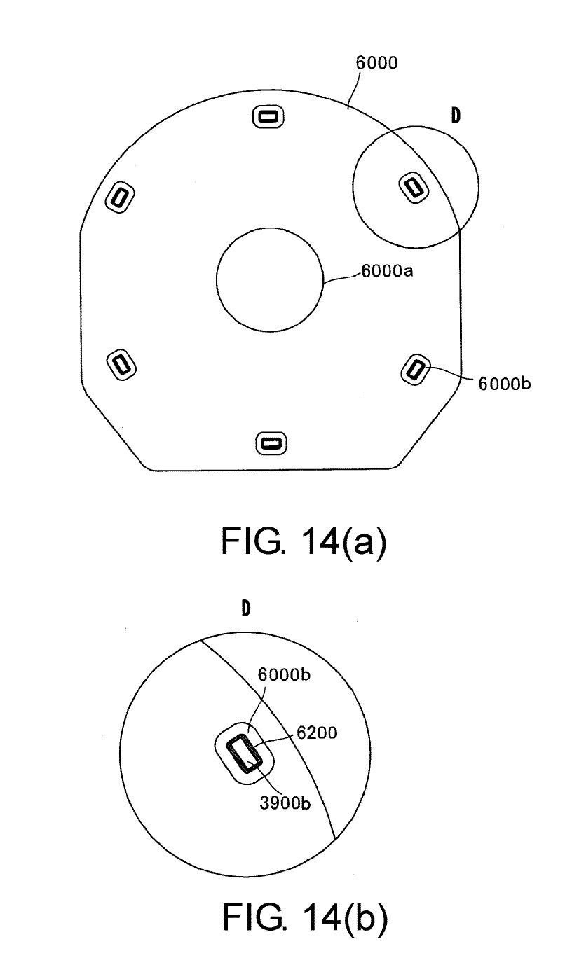

FIG. 13 is a view showing a connecting portion of the connector 3900 and the circuit board 6000 in the impact wrench 1000 according to Embodiment 3. In addition, FIG. 14(a) and FIG. 14(b) are schematic views showing a configuration of the circuit board 6000 in the impact wrench 1000 according to the first embodiment. FIG. 14(a) is a plan view showing the entirety of the circuit board 6000, and FIG. 14(b) is an enlarged view of a portion D of FIG. 14(a).

The circuit board 6000 is formed in a substantially annular shape having a circular hole portion 6a about a center thereof, and disposed behind a rear surface of the stator 3300 in the axial direction covered with the anti-vibration rubber 3600 and the insulator 3700. The output shaft 3100 of the motor 3000 is rotatably loose-fitted into the hole portion 6000a.

In addition, as shown in FIG. 14(a), six hole portions 6000b parallel to the circumferential direction are formed in the circuit board 6000. The hole portions 6000b are formed in a substantially rectangular shape, and the protrusions 3900b of the connectors 3900 are fitted into each of the hole portions 6000b. Fitting portions of the hole portions 6000b and the protrusions 3900b are soldered by solders 6200. In this state, the circuit hoard 6000 and the connectors 3900 are connected.

In the impact wrench 1000 configured as above, when a fastening work of a latch is performed, the hammer 5100 and the anvil 5200 in the output section 5000 repeatedly collide with each other. Upon collision, vibrations are generated in the output section 5000 serving as a vibration source and transmitted to the respective parts. A vibration transmission path through which the vibrations generated in the output section 5000 are transmitted is represented by an arrow P in FIG. 9. The vibration transmission path P reaches the circuit board 6000 from the output section 5000 via the trunk section 2000a of the housing 2000, the stator 3300, the insulator 3700 and the connector 3900. That is, the vibrations generated in the output section 5000 are transmitted to the circuit board 6000 via the housing 2, the stator 3300, the insulator 3700 and the connector 3900.

Here, in the impact wrench 1 of the embodiment, as shown in FIG. 11(a) and FIG. 12(a), the anti-vibration rubber 3600 is disposed between the stator 3300 and the insulator 3700. Since the anti-vibration rubber 3600 has a vibration absorbing function, vibrations transmitted from the output section 5000 via the housing 2000 and the stator 3300 are absorbed, and the amount of vibrations transmitted to the insulator 3700, the connector 3900 and the circuit board 6000 is reduced. Accordingly, since a transmission quantity of the vibrations generated in the output section 5000 to the circuit board 6000 is reduced, exfoliation of the switching element 6100 due to occurrence of flexure in the circuit board 6000 or droppage of the connector 3900 from the circuit board 6000 can be suppressed. In addition, since a transmission quantity of vibrations to the coils 3500 wound on the outer circumferential surface of the insulator 3700 or the inclined section 3900c of the connector 3900 is also reduced, occurrence of disconnection in the coils 3500 can also be prevented.

As described above, in the embodiment, since the anti-vibration rubber 3600 is disposed between the stator 3300 and the insulator 3700 on the vibration transmission path P that reaches the circuit board 6000 using the output section 5000 as a vibration source, transmission of vibrations to the respective parts disposed downstream from the stator 3300 on the vibration transmission path P can be suppressed. Accordingly, even when the tool main body is not increased in size, occurrence of flexure of the circuit board 6000, disconnection of the coils 3500, or the like, due to transmission of the vibrations can be suppressed.

### Embodiment 4

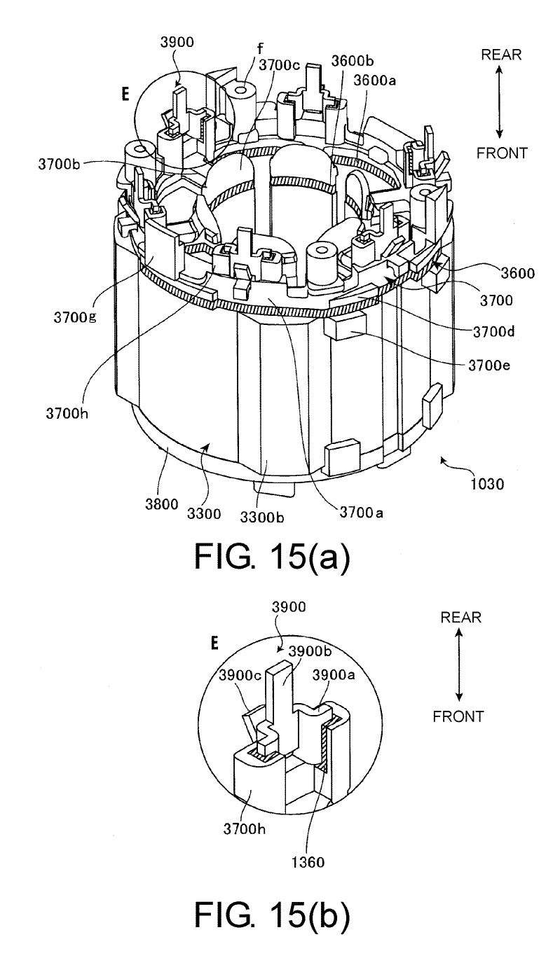

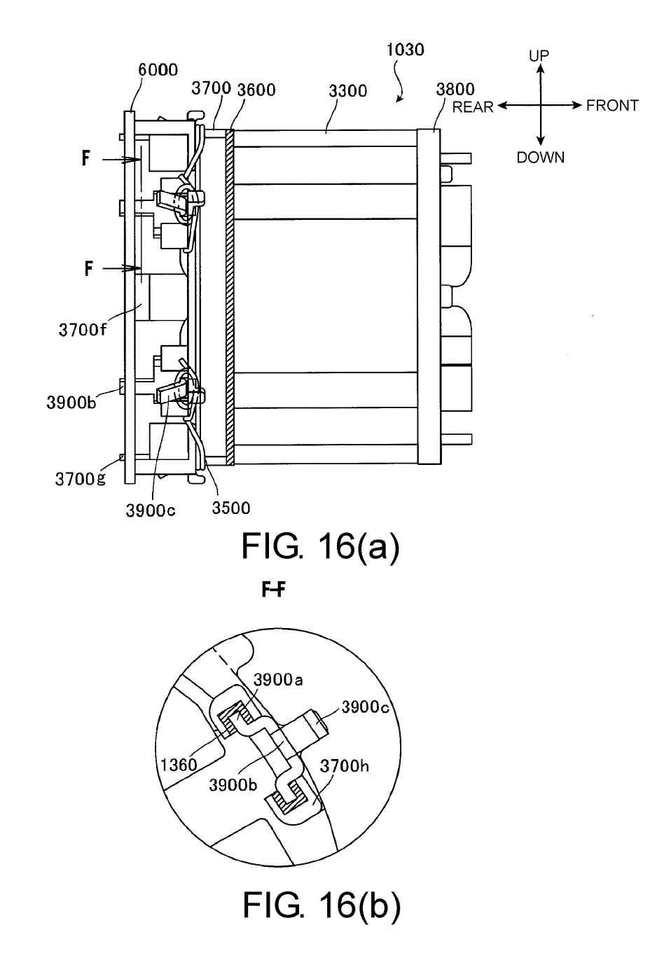

Next, an impact wrench according to Embodiment 4 will be described with reference to FIG. 15(a), FIG. 15(b), FIG. 16(a) and FIG. 16(b). The impact wrench according to the embodiment is distinguished from the impact wrench 1000 according to Embodiment 3 in that an anti-vibration rubber 1360 is disposed between the insulator 3700 and the connector 3900 in a motor 1030. Further, in the following description, the same members as Embodiment 3 are designated by the same reference numerals, and description thereof will be omitted.

FIG. 15(a) is a perspective view showing a partial configuration of the motor 1030 in the impact wrench according to Embodiment 4, and FIG. 15(b) is an enlarged view of a portion E of FIG. 15(a), showing a partially enlarged view showing an engaging portion of the connector 3900 and the insulator 3700. In addition, FIG. 16(a) and FIG. 16(b) show a side view and a partially enlarged view of a partial configuration of the motor 1030 in the impact wrench according to Embodiment 4, FIG. 16(a) is a side view of the motor 103, and FIG. 16(b) is a cross-sectional view taken along line F-F of FIG. 16(a).

In the motor 1030, as shown in FIG. 15(b) and FIG. 16(b), the anti-vibration rubber 1360 is disposed between the insulator 3700 and the connector 3900. The anti-vibration rubber 1360 is formed in a reversed “C” shape having a bottom surface, and disposed to cover the entire portion of the connector support section 3700h of the insulator 3700 that abuts the engaging section 3900a of the connector 3900. That is, the anti-vibration rubber 1360 is disposed between the insulator 3700 and the connector 3900. The anti-vibration rubber 1360 is an example of the elastic body of the disclosure and has a function of absorbing vibrations.

In the impact wrench according to Embodiment 4 having the above-mentioned configuration, in addition to the anti-vibration rubber 3600 disposed between the stator 3300 and the insulator 3700, the anti-vibration rubber 1360 is disposed also between the insulator 3700 and the connector 3900 on the vibration transmission path P (FIG. 9). Accordingly, the vibrations generated in the output section 5000 serving as the vibration source and transmitted to the housing 2000 and the stator 3300 are absorbed by the anti-vibration rubber 3600, a transmission quantity of the vibrations to the insulator 3700 is reduced, and further, the transmission quantity of vibrations absorbed by the anti-vibration rubber 1360 from the insulator 3700 to the connector 3900 is reduced. Accordingly, since the transmission quantity of the vibrations generated in the output section 5000 to the circuit board 6000 is further reduced, an effect of preventing flexure of the circuit board 6000, exfoliation of the switching element 6100 or droppage of the connecting portion of the connector 3900 is further improved. In addition, an effect of suppressing disconnection of the coils 3500 wound on the inclined section 3900c of the connector 3900 is further improved.

Further, in the embodiment, in addition to the anti-vibration rubber 3600 disposed between the stator 3300 and the insulator 3700, while the anti-vibration rubber 1360 is disposed between the insulator 3700 and the connector 3900, the disclosure is not limited thereto. The anti-vibration rubber 3600 may also be disposed only between the insulator 3700 and the connector 3900 without disposing the anti-vibration rubber 3600 between the stator 3300 and the insulator 3700. Even in this case, since the amount of vibrations transmitted to the circuit board 6000 from the insulator 3700 via the connector 3900 is reduced, occurrence of flexure of the circuit board 6000, disconnection of the coils 3500, or the like, due to transmission of vibrations, can be suppressed.

In addition, the anti-vibration rubbers may also be disposed between the board positioning sections 3700f and 3700g of the insulator 3700 and the circuit board 6000. In this case, the amount of vibrations directly transmitted to the circuit board 6000 from the insulator 3700 without going through the connector 3900 is reduced. Accordingly, an effect of suppressing and preventing flexure of the circuit board 6000 can be further improved.

### Embodiment 5

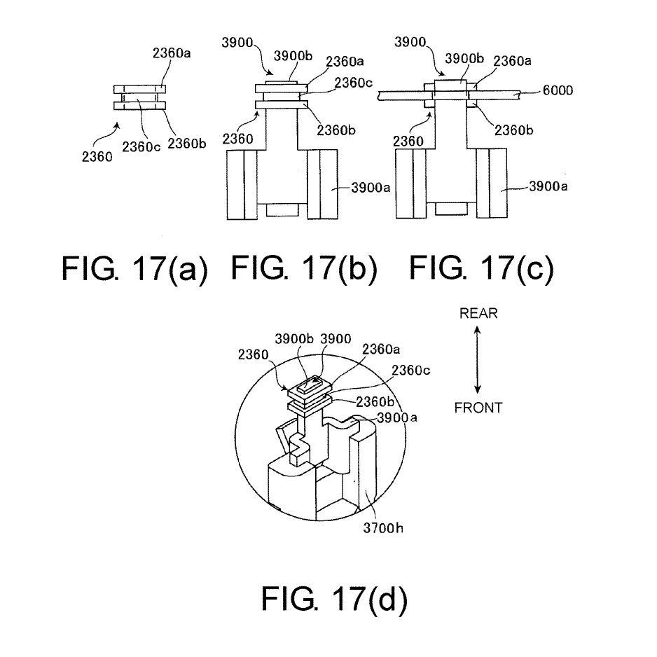

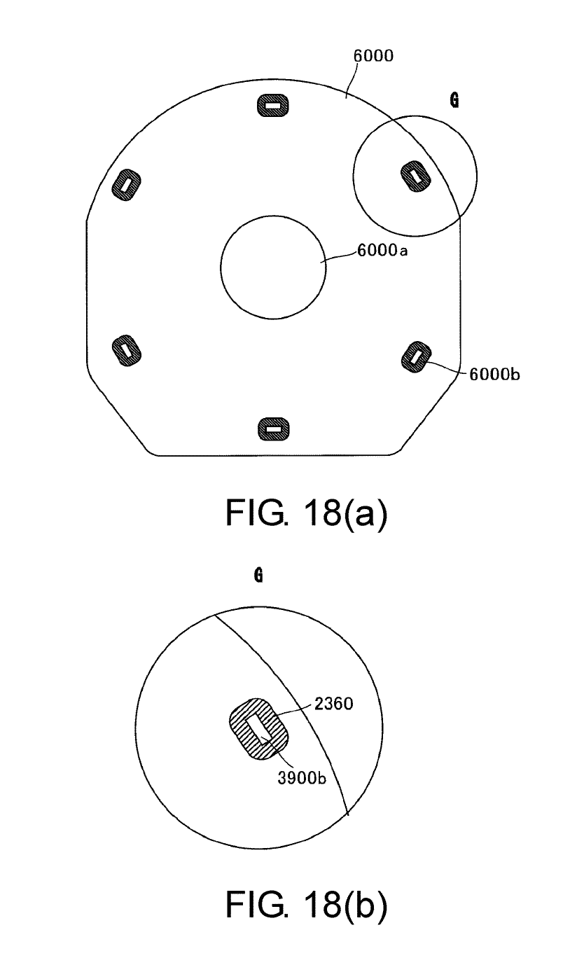

Next, an impact wrench according to Embodiment 5 will be described with reference to FIG. 17(a) to FIG. 18(b). The impact wrench according to the embodiment is distinguished from the impact wrench 1000 according to Embodiment 3 in that a conductive rubber 2360 is disposed between the connector 3900 and the circuit board 6000. Further, in the following description, the same members as Embodiment 3 are designated by the same reference numerals, and description thereof will be omitted.

FIG. 17(a) to FIG. 17(d) are views showing a configuration of the conductive rubber 2360 and the connector 3900 in the impact wrench according to Embodiment 5. FIG. 17(a) is a view showing a configuration of the conductive rubber 2360 and FIG. 17(b) is a view showing an engaging portion of the conductive rubber 2360 and the connector 3900. In addition, FIG. 17(c) is a view showing a connecting portion of the conductive rubber 2360, the connector 3900 and the circuit hoard 6000, and FIG. 17(d) is a view showing an engaging portion of the connector 3900 and the insulator 3700. In addition, FIG. 18(a) and FIG. 18(h) are schematic views showing a configuration of the circuit board 6000 in the impact wrench according to Embodiment 5. FIG. 18(a) is a plan view showing the entirety of the circuit board 6000, and FIG. 18(b) is an enlarged view of a portion G in FIG. 18(a).

As shown in FIG. 17(a), the conductive rubber 2360 is constituted by a tubular section 2360c in which a substantially rectangular hole portion is formed in a substantially elliptical columnar shape, and a pair of conductive rubbers 2360a and 2360b installed at both ends in the axial direction. The conductive rubber 2360 is an example of the elastic body of the disclosure and has conductivity and a function of absorbing vibrations. As shown in FIG. 17(b) and FIG. 17(d), the conductive rubber 2360 is fitted onto the protrusion 3900b of the connector 3900.

A configuration of the circuit board 6000 is the same as in the first embodiment, and as shown in FIG. 18(a), the circular hole portion 6000a in which the output shaft 3100 is loose-fitted is formed at a center thereof, and six hole portions 6000b into which the connectors 3900 are fitted are thrilled in the circumferential direction at equal intervals. The protrusions 3900b of the connectors 3900 are fitted into the hole portions 6000b. Here, as shown in FIG. 17(c), in the protrusion 3900b onto which the conductive rubber 2360 is fitted, the tubular section 2360c serving as a portion disposed between the conductive rubber 2360a and the conductive rubber 2360b is disposed in the hole portion 6000b, and the conductive rubber 2360a and the conductive rubber 2360b abut a rear surface and a front surface of the circuit board 6000, respectively. In this state, the circuit hoard 6000 and the connector 3900 are connected via the conductive rubber 2360.

In the impact wrench according to Embodiment 5 configured as above, in addition to the anti-vibration rubber 3600 disposed between the stator 3300 and the insulator 3700, the conductive rubber 2360 is disposed also between the connector 3900 and the circuit board 6000 on the vibration transmission path P (FIG. 9). Accordingly, the vibrations generated in the output section 5000 serving as a vibration source and transmitted to the housing 2000 and the stator 3300 are absorbed by the anti-vibration rubber 3600, a transmission quantity of the vibrations to the insulator 3700 is reduced, and further, a transmission quantity of the vibrations from the connector 3900 to the circuit board 6000 absorbed by the conductive rubber 2360 is reduced. Accordingly, since the transmission quantity of the vibrations generated in the output section 5000 to the circuit board 6000 is further reduced, an effect of suppressing flexure of the circuit board 6000 or exfoliation of the switching element 6100 and suppressing droppage of the connecting portion of the connector 3900 without damage to conductivity with the circuit board 6000 is obtained. In addition, an effect of suppressing disconnection of the coils 3500 is also improved.

Further, in the embodiment, in addition to the anti-vibration rubber 3600 between the stator 3300 and the insulator 3700, while the conductive rubber 2360 is disposed between the connector 3900 and the circuit board 6000, the disclosure is not limited thereto. The conductive rubber 2360 may be disposed only between the connector 3900 and the circuit board 6000 without disposing the anti-vibration rubber 3600 between the stator 3300 and the insulator 3700, or like the impact wrench according to Embodiment 4, the anti-vibration rubber 1360 may also be disposed between the insulator 3700 and the connector 3900. In either case, since the amount of vibrations transmitted from the connector 3900 to the circuit board 6000 is reduced, occurrence of flexure of the circuit board 6, disconnection of the coils 3500, or the like, due to transmission of the vibrations can be suppressed.

In addition, in the embodiment, while the connector 3900 is a conductive terminal, the disclosure is not limited thereto. For example, a conductive rubber may be disposed between the connector serving as a signal terminal and the circuit board.

### Embodiment 6

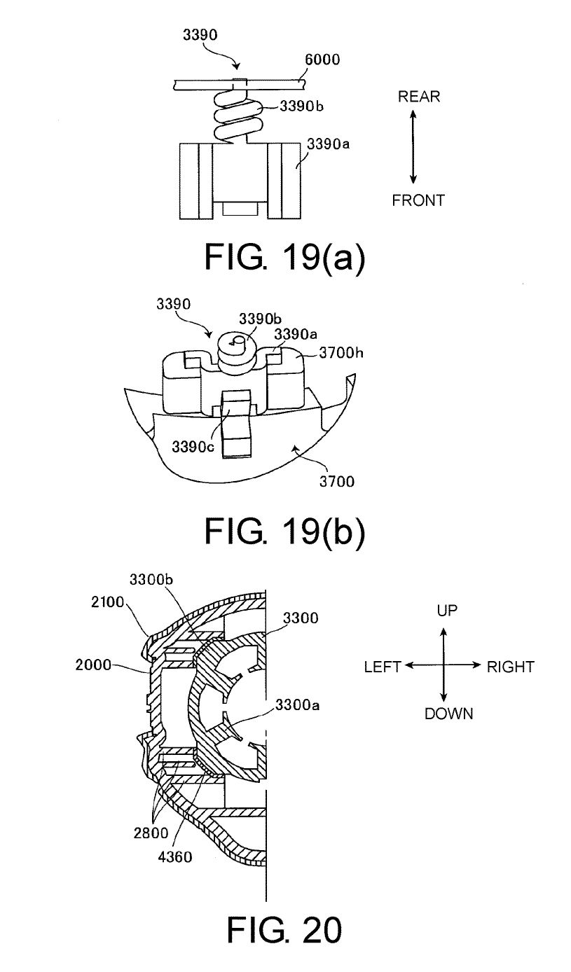

Next, an impact wrench according to Embodiment 6 will be described with reference to FIG. 19(a) and FIG. 19(b). The impact wrench according to the embodiment is distinguished from the impact wrench 1000 according to Embodiment 3 in that a protrusion 3390b of a connector 3390 is constituted by an elastic body. Further, in the following description, the same members as in Embodiment 3 are designated by the same reference numerals, and description thereof will be omitted.

FIG. 19(a) and FIG. 19(b) are views showing a configuration of the connector 3390 in the impact wrench according to Embodiment 6. FIG. 19(a) is a view showing a connecting portion of the connector 3390 and the circuit board 6000, and FIG. 19(b) is a view showing an engaging portion of the connector 3390 and the insulator 3700.

The connector 3390 is formed of a conductive material such as a resin or the like, and as shown in FIG. 19(a), has an engaging section 3390a engaged with the connector support sections 3700h of the insulator 3700, a protrusion 3390b protruding rearward in the axial direction and an inclined section 3390c inclined in the radial direction. The protrusion 3390b is formed in a spiral shape as shown in FIG. 19(a) and FIG. 19(b), and connected to the circuit board 6000 at an end portion thereof. In the embodiment, the end portion of the protrusion 3390b is fitted into the hole portion 6000b of the circuit board 6000 and fixed through soldering. The protrusion 3390b is an example of the elastic body of the disclosure, has elasticity by the spiral shape, and absorbs vibrations by elasticity thereof. That is, the connector 3390 is formed in a shape that can be elastically deformed to have a function as an elastic body.

In the impact wrench according to Embodiment 6 configured as above, in addition to the anti-vibration rubber 3600 disposed between the stator 3300 and the insulator 3700, the connector 3390 of the elastic body is disposed between the insulator 3700 and the circuit board 6000 on the vibration transmission path P (FIG. 9). Accordingly, the vibrations generated in the output section 5000 serving as a vibration source and transmitted to the housing 2000 and the stator 3300 are absorbed by the anti-vibration rubber 3600, a transmission quantity of the vibrations to the insulator 3700 is reduced, and further, the transmission quantity of the vibrations from the connector 3390 to the circuit board 6000 absorbed by the protrusion 3390b of the connector 3390 is reduced. Accordingly, since the transmission quantity of the vibrations generated in the output section 5000 to the circuit board 6000 is further reduced, an effect of suppressing flexure of the circuit board 6000 or exfoliation of the switching element 6100 and suppressing droppage of the connecting portion of the connector 3900 without damage to conductivity with the circuit board 6000 is obtained. In addition, an effect of suppressing disconnection of the coils 3500 is also improved.

Further, in the embodiment, in addition to the anti-vibration rubber 3600 disposed between the stator 3300 and the insulator 3700, while the connector 3390 of the elastic body is disposed between the insulator 3800 and the circuit board 6000, the disclosure is not limited thereto. The connector 3390 serving as the elastic body may be disposed between the stator 3300 and the insulator 3700 rather than the anti-vibration rubber 3600, or like the impact wrench according to Embodiment 4, the anti-vibration rubber 1360 may also be disposed between the insulator 3700 and the connector 3390. Even in either case, since the amount of vibrations transmitted from the connector 3390 to the circuit board 6000 is reduced, occurrence of flexure of the circuit board 6000, disconnection of the coils 3500, or the like, due to transmission of the vibrations can be suppressed.

### Embodiment 7

Next, an impact wrench according to Embodiment 7 will be described with reference to FIG. 20. The impact wrench according to the embodiment is distinguished from the impact wrench 1000 according to Embodiment 3 in that an anti-vibration rubber 4360 is disposed between the housing 2000 and the stator 3300. Further, in the following description, the same members as in Embodiment 3 are designated by the same reference numerals, and description thereof will be omitted.

FIG. 20 is a view of a connecting portion of the housing 2000 and the motor 3000 in the impact wrench according to Embodiment 7, showing a cross-sectional view taken along line A-A of FIG. 9. FIG. 20 shows only a left half of the cross-sectional view.

The four convex sections 3300b formed in the outer circumferential section of the stator 3300 are supported by the plurality of ribs 2800 protruding in the trunk section 2000a of the housing 2000. In the embodiment, as shown in FIG. 20, the anti-vibration rubbers 4360 are disposed between the convex sections 3300b and the ribs 2800. That is, the stator 3300 is fixed to the housing 2000 via the anti-vibration rubber 4360. The anti-vibration rubber 4360 is an example of the elastic body of the disclosure and has a function of absorbing vibrations.

In the impact wrench according to Embodiment 7 configured as above, in addition to the anti-vibration rubber 3600 disposed between the stator 3300 and the insulator 3700, the anti-vibration rubber 4360 is disposed also between the housing 2000 and the stator 3300 on the vibration transmission path P (FIG. 9). Accordingly, the vibrations generated in the output section 5000 serving as a vibration source and transmitted to the housing 2000 are absorbed by the anti-vibration rubber 4360, a transmission quantity of the vibrations to the stator 3300 is reduced, and the transmission quantity of the vibrations from the stator 3300 to the insulator 3700 absorbed by the anti-vibration rubber 3600 is reduced. Accordingly, since the transmission quantity of the vibrations generated in the output section 5000 to the circuit board 6000 is further reduced, an effect of suppressing flexure of the circuit board 6000 or exfoliation of the switching element 6100 and droppage of the connecting portion of the connector 3900 is further improved. In addition, since a transmission quantity of the vibrations to the coils 3500 disposed in the stator 3300 or on the outer circumferential surface of the insulator 3700, the inclined section 3900c of the connector 3900, and so on, is also reduced, an effect of suppressing occurrence of disconnection in the coils 3500 is also improved.

Further, in the embodiment, in addition to the anti-vibration rubber 3600 disposed between the stator 3300 and the insulator 3700, while the anti-vibration rubber 4360 is disposed between the housing 200 and the stator 3300, the disclosure is not limited thereto. Various combinations such as disposition of the anti-vibration rubber 4360 only between the housing 2000 and the stator 3300 without disposing the anti-vibration rubber 3600 between the stator 3300 and the insulator 3700, disposition of the anti-vibration rubber 1360 also between the insulator 3700 and the connector 3390 like the impact wrench according to Embodiment 4, disposition of the conductive rubber 2360 also between the connector 3900 and the circuit board 6000 like the impact wrench according to Embodiment 5, provision of a vibration absorbing function to the connector 3390 like the impact wrench according to Embodiment 6, or the like, are possible. Even in either case, since the amount of vibrations transmitted to the circuit board 6000 via the vibration transmission path P is reduced, occurrence of flexure of the circuit board 6000, disconnection of the coils 3500, or the like, due to transmission of the vibrations can be suppressed.

### Embodiment 8

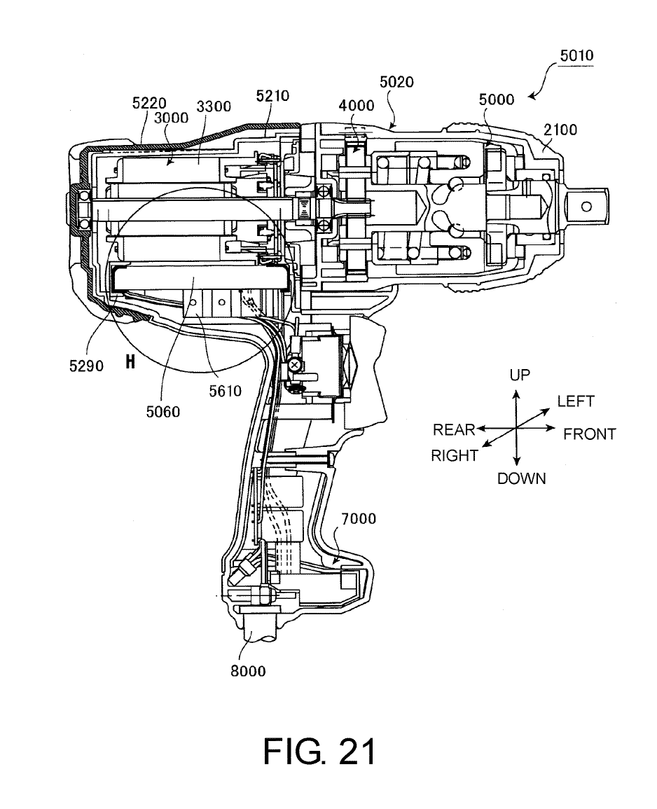

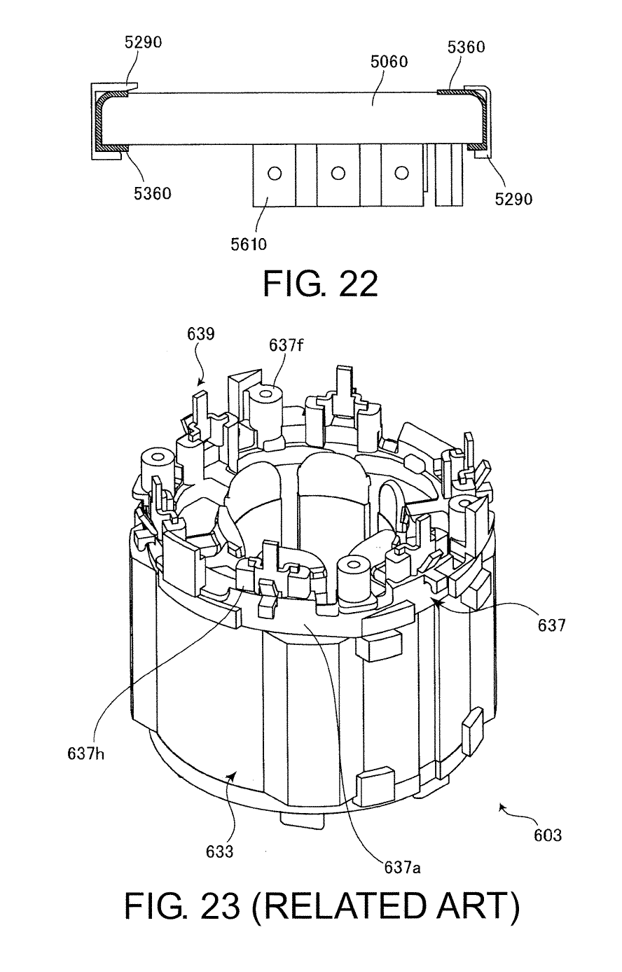

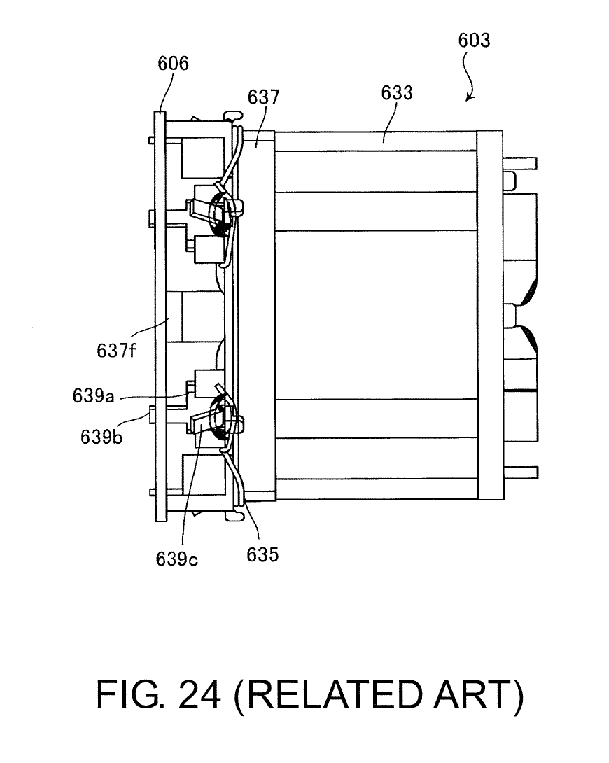

Next, an impact wrench 5010 according to Embodiment 8 will be described with reference to FIG. 21 and FIG. 22. The impact wrench 5010 according to the embodiment has a double insulation structure of a resin housing and an aluminum housing. Further, in the following description, the same members as Embodiment 3 are designated by the same reference numerals, and description thereof will be omitted.

FIG. 21 is a cross-sectional view showing a configuration of the impact wrench 5010 according to Embodiment 8. In addition, FIG. 22 is a view of a support portion of a circuit board 5060 in the impact wrench 5010 according to Embodiment 8, showing an enlarged view of a portion H in FIG. 21.

As shown in FIG. 21, the impact wrench 5010 is configured to include a housing 5020, the motor 3000, the gear mechanism 4000, the output section 5000, the circuit board 5060, the control unit 7 and the power supply cord 8000.

An outer block of the impact wrench 5010 is constituted by a housing 5210 formed of a resin, a housing 5220 formed of aluminum, and the cover 2100 formed of a resin and configured to cover the output section 5000. The housing 5210 corresponds to a motor accommodating section of the disclosure.

The circuit board 5060 is disposed under the motor 3000 and connected to the motor 3000 by a coil (not shown) extracted from the stator 3300. Further, a switching element 5610 is disposed on the circuit board 5060 opposite to the motor 3000. In addition, the circuit board 5060 is supported by ribs 5290 protruding in the housing 5210. In the embodiment, as shown in FIG. 22, an anti-vibration rubber 5360 is disposed between the circuit board 5060 and the ribs 5290. That is, the circuit board 5060 is fixed to the housing 5210 via the anti-vibration rubber 5360. The anti-vibration rubber 5360 is an example of the elastic body of the disclosure and has a function of absorbing vibrations.

In the impact wrench 5010 according to Embodiment 8 configured as above, the vibrations generated in the output section 5000 serving as a vibration source are transmitted to the motor 3000 via the housing 5210 and also transmitted to the circuit board 5060 via the housing 5210. That is, in the impact wrench 5010 according to the embodiment, a vibration transmission path (not shown) that directly reaches the circuit board 5060 from the output section 5000 via the housing 5210 is formed. The anti-vibration rubber 5360 is disposed between the housing 5210 and the circuit board 5060 on the vibration transmission path. Accordingly, since the vibrations generated in the output section 5000 and transmitted to the housing 5210 are absorbed by the anti-vibration rubber 5360 and the transmission quantity of vibrations to the circuit board 5060 are reduced, flexure of the circuit board 5060, exfoliation of elements mounted on the circuit board 5060, or the like, can be suppressed. In addition, occurrence of disconnection of the coils extracted from the motor 3000 and connected to the circuit board 5060 can also be suppressed.

Hereinabove, while the disclosure has been described based on the embodiments, the disclosure is not limited to the above-mentioned embodiments but various modifications may be made without departing from the spirit of the disclosure. In the electric working machine of the disclosure, power is supplied from a commercial power supply, i.e., an alternating current power supply to a brushless motor. On the other hand, the electric working machine of the disclosure includes an electric working machine in which a battery pack serving as a direct current power supply is attached to a working machine main body and power of the battery pack is supplied to the brushless motor. The electric working machine of the disclosure may be provided to operate a tip tool with power of the electric motor.

The electric working machine of the disclosure includes a hammer drill or a hammer driver that is configured to apply a rotating force to tip tool and a striking force in an axial direction. The electric working machine of the disclosure includes an impact driver or an impact drill that is configured to apply a rotating force to a tip tool and a striking force in a rotation direction. Further, the electric working machine includes a screwdriver, a drill, a grinder, a sander or a circular saw that is configured to apply only a rotating force to a tip tool. The electric working machine of the disclosure includes a hammer or a nail gun that is configured to apply only a striking force in an axial direction to a tip tool. The electric working machine of the disclosure includes a jigsaw or a saber saw that is configured to reciprocate a tip tool. The electric working machine of the disclosure includes a blower. A working tool includes a driver bit configured to tighten or loosen a screw member, or a saw blade configured to cut an object, in addition to a tool configured to crush an object. In addition, an electric motor serving as a power supply includes an induction motor, in addition to a brushless motor. In addition, a motor serving as a power supply includes a hydraulic motor or a pneumatic motor, in addition to an electric motor. A power conversion mechanism includes a cam mechanism, in addition to a crank mechanism.

In addition, while a circuit board on which a switching element such as a FET or the like is mounted has been exemplarily described as a board, the disclosure is not limited thereto. For example, a board on which a sensor or the like is mounted may be employed.

In the embodiment, while the electric tool is assumed to have a large output of 1000 W or more, the disclosure may be applied to an electric tool of less than 1000 W, and in this case, an effect of suppressing disconnection or the like of the coils can be further obtained. In addition, the motor is not limited to the brushless motor but may be an induction motor.

### REFERENCE SIGNS LISTS

10 . . . electric working machine, 11 . . . tip tool, 12 . . . working machine main body, 14 . . . intermediate case, 17 . . . bottom cover, 20 . . . motor housing, 21 . . . intermediate striking element, 22 . . . striking element, 23 . . . piston, 30 . . . brushless motor, 33 . . . output shaft, 71 . . . control board, 82 . . . board case, 83 . . . plate section, 82a . . . boss section, 84 . . . sidewall, 152, 153, 154, 165, 166 . . . elastic body, A1, B1 . . . axis, 1000, 5010 . . . impact wrench, 2000, 5210 . . . housing, 3000, 1030 . . . motor, 5000 . . . output section, 6000, 5060 . . . circuit board, 3300 . . . stator, 3500 . . . coil, 3600, 1360, 4360, 5360 . . . anti-vibration rubber, 3700, 3800 . . . insulator, 3900, 3390 . . . connector, 2360 . . . conductive rubber

1. (canceled)

2. The powered working machine according to claim 6, wherein a resin layer configured to cover the control board is formed in the board case.

3. The powered working machine according to claim 6, wherein the board case is disposed at a side portion of the motor in a radial direction of an output shaft of the motor.

4. The powered working machine according to claim 6, wherein a striking mechanism operated in a direction along a first axis with a power of the motor and configured to apply a striking force to the working tool is installed in the housing, and
the elastic body is interposed between the board case and the housing in the direction along the first axis.

5. The powered working machine according to claim 4, wherein the elastic body is disposed at both sides of the board case in the direction along the first axis.

6. A powered working machine configured to operate a working tool with a power of a motor, the powered working machine comprising:
a control board configured to control the motor;
a board case configured to accommodate the control board;
a housing, configured to support the board case; and
an elastic body interposed between the board case and the housing,
wherein the housing comprises:
a first housing that accommodates the motor; and
a second housing that accommodates the first housing and the board case, and
the elastic body is interposed between the board case and the first housing and/or between the board case and the second housing.

7. The powered working machine according to claim 6, wherein the board case comprises:
a plate section disposed between the first housing and the control board; and
a sidewall installed at an outer circumferential edge of the plate section, and
the elastic body comprises:
a first elastic body interposed between the plate section and the first housing; and
a second elastic body interposed between a tip of the sidewall and the second housing.

8. The powered working machine according to claim 7, wherein the first elastic body is installed throughout a region of an outer surface of the plate section.

9. A powered working machine configured to operate a working tool with a power of a motor, the powered working machine comprising:
a control board configured to control the motor;
a board case configured to accommodate the control board;
a housing, configured to support the board case; and
an elastic body interposed between the board case and the housing,
wherein the housing comprises a first housing that accommodates the motor,
the board case comprises a boss section into which a screw member is inserted to fix the board case to the first housing, and
the elastic body comprises a third elastic body installed at the boss section.

10. The powered working machine according to claim 6, wherein an output section extending in a forward/rearward direction and driven by the motor is provided, and
the elastic body is interposed between the board case and the housing in the forward/rearward direction.

11. The powered working machine according to claim 10, wherein the motor has an output shaft extending in the forward/rearward direction, and
the elastic body is interposed between the board case and the housing in the forward/rearward direction.

12. The powered working machine according to claim 10, wherein the elastic body is disposed at both sides of the board case in the forward/rearward direction.

13. The powered working machine according to claim 10, wherein the control board is accommodated in the housing while extending in the forward/rearward direction.

14. A powered working machine comprising:
a board;
a motor connected to the board;
a housing configured to accommodate the board and the motor; and
an output section extending in a forward/rearward direction and driven by the motor,
wherein an elastic body is disposed on a vibration transmission path reaching the board from the output section.

15. The powered working machine according to claim 14, wherein the elastic body is disposed between the board and the housing at both sides in the forward/rearward direction.

16. The powered working machine according to claim 6,
wherein the board case comprises a boss section into which a screw member is inserted to fix the board case to the first housing, and
the elastic body comprises a third elastic body installed at the boss section.

17. The powered working machine according to claim 9,
wherein the housing comprises a second housing that accommodates the first housing and the board case, and
the elastic body is interposed between the board case and the first housing and/or between the board case and the second housing.
